(19) United States
(12) Patent Application Publication
(10) Pub. No.: US 2026/0073854 A1
(43) Pub. Date: Mar. 12, 2026

(54) PIXEL CIRCUIT AND DRIVING METHOD THEREFOR, AND DISPLAY PANEL

(71) Applicant: Yungu (Gu’an) Technology Co., Ltd., Langfang (CN)

(72) Inventors: Enqing GUO, Langfang (CN); Cuili GAI, Langfang (CN); Junfeng LI, Langfang (CN); Kangguan PAN, Langfang (CN); Shuang GUO, Langfang (CN); Xiaoyang JIN, Langfang (CN)

(73) Assignee: Yungu (Gu’an) Technology Co., Ltd., Langfang (CN)

(21) Appl. No.: 19/394,807

(22) Filed: Nov. 19, 2025

Related U.S. Application Data
(63) Continuation of application No. PCT/CN2023/128520, filed on Oct. 31, 2023.

(30) Foreign Application Priority Data
May 31, 2023 (CN) 202310637058.6
Sep. 28, 2023 (CN) 202311282413.9

(51) Int. Cl. G09G 3/32

(52) U.S. Cl. CPC G09G 3/32; G09G 2300/0819; G09G 2300/0852; G09G 2300/0861; G09G 2310/08; G09G 2320/0233; G09G 2320/0257

(57) ABSTRACT

A pixel circuit and a driving method therefor, and a display panel are provided. The pixel circuit includes a driver module, a signal supply terminal, a compensation module, and a coupling module. The compensation module is configured to compensate for a threshold voltage of the driver module in a compensation phase. The signal supply terminal supplies a fixed voltage to the coupling module in an initialization phase and supplies a data voltage to the coupling module in a data writing phase, the coupling module is configured to couple a voltage containing information about the data voltage to a control terminal of the driver module via the compensation module in the data writing phase, where the data writing phase is later than the compensation phase.

### CROSS-REFERENCE TO RELATED APPLICATIONS

The present application is a continuation of International Application No. PCT/CN2023/128520 filed on Oct. 31, 2023, which claims priority to Chinese Patent Application No. 202310637058.6, filed with the China National Intellectual Property Administration on May 31, 2023, and to Chinese Patent Application No. 202311282413.9, filed with the China National Intellectual Property Administration on Sep. 28, 2023, both of which are incorporated herein by reference in their entireties.

### FIELD

Embodiments of the present application relate to the field of display technologies, and for example, to a pixel circuit and a driving method therefor, and a display panel.

### BACKGROUND

With the continuous development of display technologies, people have increasingly high requirements for display quality.

A display panel typically includes a plurality of pixel circuits. The pixel circuits include driver transistors, and the driver transistors generate drive signals to drive light-emitting elements to emit light for display. However, the display panel is subject to display unevenness, severely affecting display quality.

### SUMMARY

Embodiments of the present application provide a pixel circuit and a driving method therefor, and a display panel, to improve display quality.

According to an embodiment of the present application, a pixel circuit is provided. The pixel circuit includes: a driver module, a signal supply terminal, a compensation module, and a coupling module, where
the compensation module is configured to compensate for a threshold voltage of the driver module in a compensation phase; and
the signal supply terminal supplies a fixed voltage to the coupling module in an initialization phase and supplies a data voltage to the coupling module in a data writing phase, and the coupling module is configured to couple a voltage containing information about the data voltage to a control terminal of the driver module via the compensation module in the data writing phase, where the data writing phase is later than the compensation phase.

According to another embodiment of the present application, a pixel circuit is provided. The pixel circuit includes: a driver module, a signal supply terminal, a compensation module, and a coupling module, where
the compensation module is connected between a control terminal and a first terminal of the driver module, and the compensation module is configured to compensate for a threshold voltage of the driver module; and
the coupling module is connected between the first terminal of the driver module and the signal supply terminal, the signal supply terminal is configured to supply a fixed voltage and a data voltage, and the coupling module is configured to couple a voltage containing information about the data voltage to the control terminal of the driver module via the compensation module.

According to another embodiment of the present application, a pixel circuit is provided. The pixel circuit includes: a driver module, a voltage writing module, a compensation module, and a coupling module, where
the compensation module is connected between a control terminal and a first terminal of the driver module, and the compensation module is configured to compensate for a threshold voltage of the driver module; and
the coupling module is connected between the first terminal of the driver module and the voltage writing module, the voltage writing module is configured to output a fixed voltage to the coupling module and output a data voltage to the coupling module, and the coupling module is configured to couple a voltage containing information about the data voltage to the control terminal of the driver module via the compensation module.

According to another embodiment of the present application, a pixel circuit is provided. The pixel circuit includes: a driver module, a data writing module, a first initialization module, a compensation module, and a coupling module, where
the compensation module is connected between a control terminal and a first terminal of the driver module, and the compensation module is configured to compensate for a threshold voltage of the driver module;
the data writing module and the first initialization module are connected at a first node; and
the coupling module is connected between the first terminal of the driver module and the first node, the first initialization module is configured to transmit a fixed voltage to the coupling module, and the coupling module is configured to couple, to the control terminal of the driver module via the compensation module, a voltage transmitted by the data writing module and containing information about a data voltage.

According to another embodiment of the present application, a driving method for a pixel circuit is provided. The driving method includes:
in an initialization phase, supplying a fixed voltage to a coupling module;
in a compensation phase, controlling a compensation module to compensate for a threshold voltage of a driver module; and
in a data writing phase, supplying a data voltage to the coupling module, and controlling the coupling module to couple a voltage containing information about the data voltage to a control terminal of the driver module via the compensation module.

In the embodiments of the present application, threshold compensation and data writing for the driver module are performed at different times by setting the data writing phase to be later than the compensation phase, and the threshold compensation is performed before the data voltage is written into the control terminal of the driver module, and the compensation phase and the data writing phase do not affect each other. In this way, the time of the threshold compensation is not affected by the data writing phase. Even at a high refresh rate, the threshold voltage of the driver module can be fully compensated, and variations in driver module characteristics corresponding to different pixels can be reduced, thereby facilitating the mitigation of variations in display brightness and the enhancement of uniformity of display quality.

It should be understood that the content described in this section is not intended to identify key or important features of embodiments of the present application, and not intended to limit the scope of the present application. Other features of the present application will become easy to understand through the following description.

### BRIEF DESCRIPTION OF THE DRAWINGS

FIG. 1 is a schematic diagram of a signal flow of a pixel circuit according to an embodiment of the present application;

FIG. 2 is a schematic diagram of a signal flow of another pixel circuit according to an embodiment of the present application;

FIG. 3 is a schematic diagram of a signal flow of another pixel circuit according to an embodiment of the present application;

FIG. 4 is a schematic diagram of a structure of a pixel circuit according to an embodiment of the present application;

FIG. 5 is a schematic diagram of a structure of another pixel circuit according to an embodiment of the present application;

FIG. 6 is a schematic diagram of a structure of another pixel circuit according to an embodiment of the present application;

FIG. 7 is a schematic diagram of driving timing of a pixel circuit according to an embodiment of the present application;

FIG. 8 is a schematic diagram of a structure of another pixel circuit according to an embodiment of the present application;

FIG. 9 is a schematic diagram of driving timing of another pixel circuit according to an embodiment of the present application;

FIG. 10 is a schematic diagram of a structure of another pixel circuit according to an embodiment of the present application;

FIG. 11 is a schematic diagram of a structure of another pixel circuit according to an embodiment of the present application;

FIG. 12 is a schematic diagram of a structure of another pixel circuit according to an embodiment of the present application;

FIG. 13 is a schematic diagram of driving timing of another pixel circuit according to an embodiment of the present application;

FIG. 14 is a schematic diagram of a structure of another pixel circuit according to an embodiment of the present application;

FIG. 15 is a schematic diagram of driving timing of another pixel circuit according to an embodiment of the present application;

FIG. 16 is a schematic diagram of a structure of another pixel circuit according to an embodiment of the present application;

FIG. 17 is a schematic diagram of a structure of another pixel circuit according to an embodiment of the present application;

FIG. 18 is a schematic diagram of a structure of another pixel circuit according to an embodiment of the present application;

FIG. 19 is a schematic diagram of a structure of another pixel circuit according to an embodiment of the present application;

FIG. 20 is a schematic diagram of driving timing of another pixel circuit according to an embodiment of the present application;

FIG. 21 is a schematic diagram of a structure of another pixel circuit according to an embodiment of the present application;

FIG. 22 is a schematic diagram of driving timing of another pixel circuit according to an embodiment of the present application;

FIG. 23 is a schematic diagram of a structure of another pixel circuit according to an embodiment of the present application;

FIG. 24 is a schematic diagram of driving timing of another pixel circuit according to an embodiment of the present application;

FIG. 25 is a schematic diagram of a structure of another pixel circuit according to an embodiment of the present application;

FIG. 26 is a schematic diagram of driving timing of another pixel circuit according to an embodiment of the present application;

FIG. 27 is a schematic diagram of driving timing of another pixel circuit according to an embodiment of the present application;

FIG. 28 is a flowchart of a driving method for a pixel circuit according to an embodiment of the present application;

FIG. 29 is a flowchart of another driving method for a pixel circuit according to an embodiment of the present application;

FIG. 30 is a flowchart of another driving method for a pixel circuit according to an embodiment of the present application; and

FIG. 31 is a schematic diagram of a structure of a display panel according to an embodiment of the present application.

### DETAILED DESCRIPTION OF THE EMBODIMENTS

As described in the background, a display panel is subject to poor display quality. Through research, the inventors have found that the cause of the above-mentioned case is as follows. A driver transistor in a pixel circuit may be subject to a threshold voltage drift due to characteristics of the driver transistor, and driver transistors in different pixel circuits have different levels of threshold drift. Consequently, there are variations in drive currents, resulting in display unevenness, and reducing display uniformity. Threshold compensation is often used to reduce an impact caused by the threshold drift of the driver transistor. However, since a threshold compensation time is short, the threshold voltage of the driver transistor cannot be fully compensated, or the presence of potential coupling leads to a compensation loss. As a result, an overall compensation effect is poor, and there are still cases such as poor display brightness uniformity and severe image sticking.

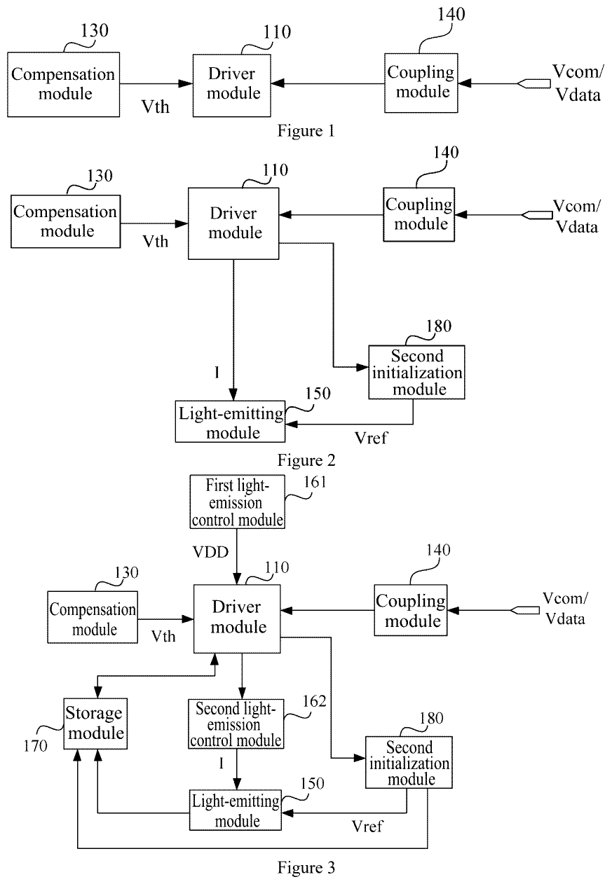

With respect to the above-mentioned case, an embodiment of the present application supplies a pixel circuit. FIG. 1 is a schematic diagram of a signal flow of a pixel circuit according to an embodiment of the present application. FIG. 1 merely shows a direction of the signal flow between modules and does not represent a connection relationship. With reference to FIG. 1, the pixel circuit provided in this embodiment of the present application includes a driver module 110, a signal supply terminal, a compensation module 130, and a coupling module 140.

The compensation module 130 is configured to compensate for a threshold voltage Vth of the driver module 110 in a compensation phase.

The signal supply terminal supplies a fixed voltage Vcom to the coupling module 140 in an initialization phase and supplies a data voltage Vdata to the coupling module 140 in a data writing phase, and the coupling module 140 is configured to couple a voltage containing information about the data voltage Vdata to a control terminal of the driver module 110 via the compensation module 130 in the data writing phase, where the data writing phase is later than the compensation phase.

Specifically, an operating process of the pixel circuit provided in this embodiment includes at least the compensation phase and the data writing phase.

In the compensation phase, the signal supply terminal supplies the fixed voltage Vcom to a first terminal of the coupling module 140, and a voltage of the first terminal of the coupling module 140 is constant. The compensation module 130 transmits the voltage of the first terminal of the driver module 110 to the control terminal of the driver module, the driver module 110 generates a current flowing from the first terminal of the driver module to a second terminal, and when a voltage difference between the control terminal and the second terminal of the driver module 110 is equal to the threshold voltage Vth of the driver module 110, the driver module 110 is turned off. A voltage associated with the threshold voltage Vth of the driver module 110 is stored at a second terminal of the coupling module 140, and the compensation module 130 transmits the voltage to the control terminal of the driver module 110, and a voltage of the control terminal of the driver module 110 is the voltage associated with the threshold voltage Vth of the driver module, thereby implementing threshold compensation for the driver module 110.

In the data writing phase, the signal supply terminal supplies the data voltage Vdata to the first terminal of the coupling module 140, the voltage of the first terminal of the coupling module 140 jumps from the fixed voltage Vcom to the data voltage Vdata, and the coupling module 140 couples the voltage containing the information about the data voltage Vdata to the control terminal of the driver module 110 via the compensation module 130, and the voltage of the control terminal of the driver module 110 is associated with the data voltage Vdata, thereby implementing data writing. The voltage containing the information about the data voltage Vdata may be a difference between the data voltage Vdata and the fixed voltage Vcom.

In this embodiment, the data writing phase is later than the compensation phase. In other words, threshold compensation and data writing for the driver module are performed at different times, and the threshold compensation is performed before the data voltage is written into the control terminal of the driver module, and the compensation phase and the data writing phase do not affect each other. In this way, the time of the threshold compensation is not affected by the data writing phase. Even at a high refresh rate, the threshold voltage of the driver module can be fully compensated, and variations in driver module characteristics corresponding to different pixels can be reduced, thereby facilitating the mitigation of variations in display brightness and the enhancement of uniformity of display quality.

Further, in this embodiment, a start time of the data writing phase is later than an end time of the compensation phase, and the data writing phase and the compensation phase are completely separated, and the compensation phase and the data writing phase do not affect each other. In this way, the time of the threshold compensation is not limited by a line time.

FIG. 2 is a schematic diagram of a signal flow of another pixel circuit according to an embodiment of the present application. With reference to FIG. 2, on the basis of the above-described embodiments, the pixel circuit further includes a second initialization module 180. The second initialization module 180 is configured to control, in the compensation phase, the first terminal of the driver module 110 to discharge via the driver module 110 and the second initialization module 180, and the compensation module 130 is configured to compensate for the threshold voltage Vth of the driver module 110 in the compensation phase based on a voltage present after the first terminal of the driver module 110 discharges.

The second initialization module 180 is turned on in the compensation phase, to provide a discharge path for discharging of the driver module 110. Specifically, the control terminal and the first terminal of the driver module 110 are connected, the first terminal of the driver module 110 discharges via the driver module 110 and the second initialization module 180, and when the voltage difference between the control terminal and the second terminal of the driver module 110 is equal to the threshold voltage Vth of the driver module 110, the driver module 110 is turned off, and the threshold voltage compensation for the driver module 110 is completed.

With continued reference to FIG. 2, the pixel circuit further includes a light-emitting module 150. The second initialization module 180 is further configured to transmit an initialization voltage Vref to the light-emitting module 150 at least in the initialization phase, to initialize a voltage remaining on the light-emitting module 150.

FIG. 3 is a schematic diagram of a signal flow of another pixel circuit according to an embodiment of the present application. With reference to FIG. 3, on the basis of the above-described embodiments, the pixel circuit further includes a first light-emission control module 161 and a second light-emission control module 162. The first light-emission control module 161 is configured to transmit a first supply voltage VDD to the first terminal of the driver module 110 in the initialization phase and a light-emission phase and stop transmitting the first supply voltage VDD to the first terminal of the driver module 110 in the compensation phase, and a voltage stored at the first terminal of the driver module 110 can be discharged via the driver module 110 and the second initialization module 180.

The second light-emission control module 162 is configured to transmit the voltage of the first terminal of the driver module 110 to the second initialization module 180 in the compensation phase for discharging. The second light-emission control module 162 is further configured to transmit a drive current I generated by the driver module 110 to the light-emitting module 150 in the light-emission phase, to drive the light-emitting module 150 to emit light.

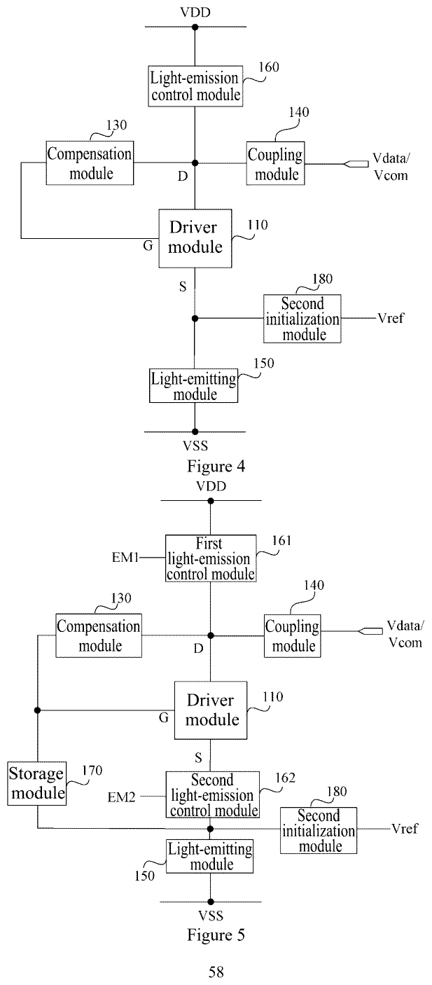

In another optional implementation of the present application, FIG. 4 is a schematic diagram of a structure of a pixel circuit according to an embodiment of the present application. With reference to FIG. 4, the pixel circuit provided in this embodiment includes a driver module 110, a signal supply terminal, a compensation module 130, and a coupling module 140. The compensation module 130 is connected between a control terminal G and a first terminal D of the driver module 110, and the compensation module 130 is configured to compensate for a threshold voltage Vth of the driver module 110. The coupling module 140 is connected between the first terminal D of the driver module 110 and the signal supply terminal, the signal supply terminal is configured to supply a fixed voltage Vcom and a data voltage Vdata, and the coupling module 140 is configured to couple a voltage containing information about the data voltage Vdata to the control terminal G of the driver module 110 via the compensation module 130.

Using the pixel circuit shown in FIG. 4 as an example, an operating process of the pixel circuit includes at least an initialization phase, a compensation phase, a data writing phase, and a light-emission phase.

In the initialization phase, the compensation module 130 is controlled to be turned on, and a first supply voltage VDD initializes the first terminal D and the control terminal G of the driver module 110; at the same time, the signal supply terminal supplies the fixed voltage Vcom to a first terminal of the coupling module 140, to initialize the first terminal of the coupling module 140.

In the compensation phase, the compensation module 130 is controlled to be continuously on, the compensation module 130 connects the control terminal G and the first terminal D of the driver module 110, the driver module 110 generates, under the action of the first supply voltage VDD, a current flowing from the first terminal D of the driver module to a second terminal S, and when a voltage difference between the control terminal G and the second terminal S of the driver module 110 is equal to the threshold voltage Vth of the driver module 110, the driver module 110 is turned off. Therefore, a voltage of the control terminal G of the driver module 110 is a voltage associated with the threshold voltage Vth of the driver module, thereby implementing threshold compensation for the driver module 110. In this process, the signal supply terminal still supplies the fixed voltage Vcom.

In the data writing phase, the signal supply terminal supplies the data voltage Vdata to the first terminal of the coupling module 140, the voltage of the first terminal of the coupling module 140 jumps from the fixed voltage Vcom to the data voltage Vdata, and the coupling module 140 couples a voltage associated with the data voltage Vdata to the control terminal G of the driver module 110 via the compensation module 130, and the voltage of the control terminal G of the driver module 110 is associated with the data voltage Vdata, thereby implementing data writing.

In the light-emission phase, the driver module 110 generates a drive current based on the voltage of the control terminal G of the driver module, to drive the light-emitting module 150 to emit light.

In this embodiment of the present application, the compensation module is disposed between the control terminal and the first terminal of the driver module, the compensation module is controlled to be turned on in the compensation phase, and the compensation module compensates for the threshold voltage of the driver module based on a voltage present after the first terminal of the driver module discharges via the driver module. In the data writing phase, the voltage transmitted from the signal supply terminal to the first terminal of the coupling module is controlled to jump from the fixed voltage to the data voltage, and the coupling module couples the data voltage to the control terminal of the driver module via the compensation module, to write the data voltage. In this embodiment, threshold compensation and data writing for the driver module are performed at different times, and the threshold compensation is performed before the data voltage is written into the control terminal of the driver module, and the threshold compensation phase and the data writing phase do not affect each other. In this way, the time of the threshold compensation is not affected by the data writing phase. Even at a high refresh rate, the threshold voltage of the driver module can be fully compensated, and variations in driver module characteristics corresponding to different pixels can be reduced, thereby facilitating the mitigation of variations in display brightness and the enhancement of uniformity of display quality.

With continued reference to FIG. 4, in one embodiment, the pixel circuit provided in this embodiment further includes a light-emission control module 160, and the light-emission control module 160, the driver module 110, and the light-emitting module 150 are connected between a first supply voltage terminal and a second supply voltage terminal. The light-emission control module 160 may be configured to break a connection between the first terminal D of the driver module 110 and the first supply voltage terminal in the compensation phase, and the voltage of the first terminal D of the driver module 110 can be discharged via the driver module 110. Certainly, in other embodiments, the light-emission control module 160 may not be disposed between the first terminal D of the driver module 110 and the first supply voltage terminal, and the voltage of the first terminal D of the driver module 110 may be controlled by controlling whether the first supply voltage terminal is connected to the first supply voltage VDD, to achieve the same effect.

In one embodiment, the pixel circuit further includes a second initialization module 180. The second initialization module 180 is connected between an initialization signal line and a first terminal of the light-emitting module 150, and is configured to initialize a potential of the first terminal of the light-emitting module 150. In the compensation phase, the second initialization module 180 is controlled to be turned on, to provide a discharge path for the first terminal D of the driver module 110.

Specifically, the second initialization module 180 is configured to transmit an initialization voltage Vref to the first terminal of the light-emitting module 150 in the initialization phase, to initialize the potential of the first terminal of the light-emitting module 150. The initialization voltage Vref is lower than a turn-on voltage of the light-emitting module 150. For example, the initialization voltage Vref may be a negative voltage. In the compensation phase, the second initialization module 180 and the compensation module 130 are kept in an on state, the control terminal G and the first terminal D of the driver module 110 are connected, the voltage of the first terminal D of the driver module 110 is discharged via the driver module 110 and the second initialization module 180, and when a voltage between the control terminal G and the first terminal D of the driver module 110 is Vref+Vth, the driver module 110 is turned off. Thus, the control terminal G of the driver module 110 is initialized while threshold voltage compensation for the driver module 110 is completed. In addition, because the potential of the first terminal of the light-emitting module 150 is always kept at the initialization voltage Vref in the initialization phase and the compensation phase, the light-emitting module 150 can be prevented from “unexpected light emission” in a non-light-emission phase.

In a specific implementation of the present application, FIG. 5 is a schematic diagram of a structure of another pixel circuit according to an embodiment of the present application. With reference to FIG. 5, on the basis of the above-described embodiments, the pixel circuit provided in this embodiment further includes a first light-emission control module 161 and a second light-emission control module 162. The first light-emission control module 161 is connected between the first supply voltage terminal and the first terminal D of the driver module 110, the second light-emission control module 162 is connected between the second terminal S of the driver module 110 and the first terminal of the light-emitting module 150, and a second terminal of the light-emitting module 150 is connected to the second supply voltage terminal. A control terminal of the first light-emission control module 161 is connected to a first light-emission control signal line, and a control terminal of the second light-emission control module 162 is connected to a second light-emission control signal line. The first light-emission control module 161 is configured to, in response to a first light-emission control signal EM1 on the first light-emission control signal line, be turned on at least in the light-emission phase and be turned off in the compensation phase and the data writing phase. The second light-emission control module 162 is configured to, in response to a second light-emission control signal EM2 on the second light-emission control signal line, be turned on at least in the compensation phase and the light-emission phase.

In one embodiment, the pixel circuit further includes a storage module 170 connected between the control terminal G of the driver module 110 and the first terminal of the light-emitting module 150 and configured to store a voltage difference between the control terminal G of the driver module 110 and the first terminal of the light-emitting module 150.

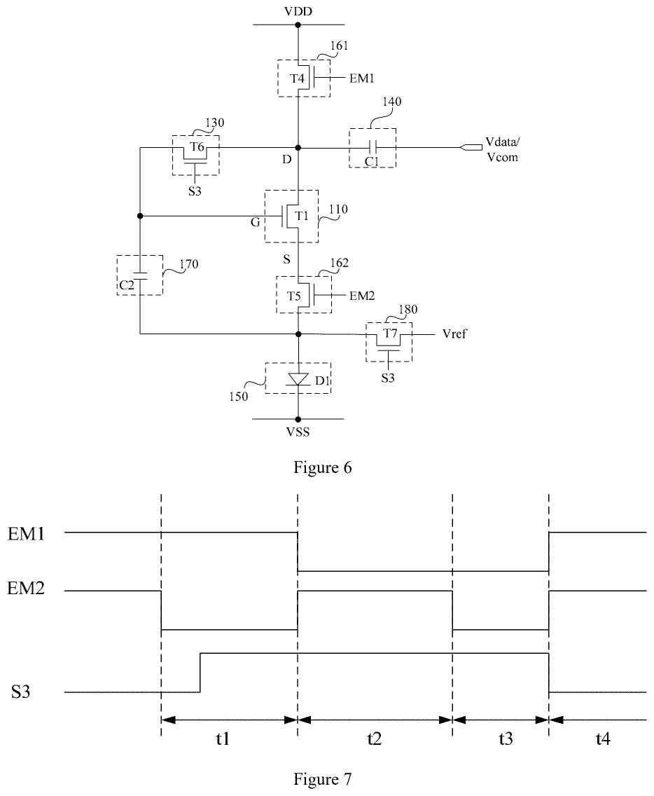

FIG. 6 is a schematic diagram of a structure of another pixel circuit according to an embodiment of the present application, and is specifically a schematic diagram of a structure of the pixel circuit shown in FIG. 5 that is detailed as devices. A control terminal of the second initialization module 180 is connected to a third scan line, and a control terminal of the compensation module 130 is connected to the third scan line. With reference to FIG. 6, in one embodiment, the driver module 110 includes a first transistor T1, the first light-emission control module 161 includes a fourth transistor T4, the second light-emission control module 162 includes a fifth transistor T5, and the light-emitting module 150 includes a light-emitting diode D1. A gate of the fourth transistor T4 is connected to the first light-emission control signal line, a first electrode of the fourth transistor T4 is connected to the first supply voltage terminal, a second electrode of the fourth transistor T4 is connected to a first electrode of the first transistor T1, a second electrode of the first transistor T1 is connected to a first electrode of the fifth transistor T5, a second electrode of the fifth transistor T5 is connected to a first electrode of the light-emitting diode D1, a second electrode of the light-emitting diode D1 is connected to the second supply voltage terminal, and a gate of the fifth transistor T5 is connected to the second light-emission control signal line.

The coupling module 140 includes a first capacitor C1, the compensation module 130 includes a sixth transistor T6, and the second initialization module 180 includes a seventh transistor T7. A first electrode of the first capacitor C1 is connected to the signal supply terminal, a second electrode of the first capacitor C1 is connected to the first electrode of the first transistor T1, a first electrode of the sixth transistor T6 is connected to the first electrode of the first transistor T1, a second electrode of the sixth transistor T6 is connected to a gate of the first transistor T1, a gate of the sixth transistor T6 is connected to the third scan line, a first electrode of the seventh transistor T7 is connected to the initialization signal line, a second electrode of the seventh transistor T7 is connected to the first electrode of the light-emitting diode D1, and a gate of the seventh transistor T7 is connected to the third scan line.

The storage module 170 includes a second capacitor C2, a first electrode of the second capacitor C2 is connected to the control terminal G of the driver module 110, and a second electrode of the second capacitor C2 is connected to the first terminal of the light-emitting module 150.

FIG. 7 is a schematic diagram of driving timing of a pixel circuit according to an embodiment of the present application, applicable to the pixel circuit shown in FIG. 6. A specific operating process of the pixel circuit provided in this embodiment of the present application is described by using an example in which each transistor shown in FIG. 6 is an N-type transistor. With reference to FIG. 6 and FIG. 7, the operating process of the pixel circuit provided in this embodiment includes an initialization phase t1, a compensation phase t2, a data writing phase t3, and a light-emission phase t4.

In the initialization phase t1, a third scan signal S3 is at an on level, such as a high level. The first light-emission control signal EM1 is at an on level, such as a high level. The second light-emission control signal EM2 is at an off level, such as a low level. Therefore, the fourth transistor T4, the sixth transistor T6, and the seventh transistor T7 are turned on. The signal supply terminal supplies the fixed voltage Vcom to the first electrode of the first capacitor C1, the first supply voltage VDD is transmitted through the fourth transistor T4 to a point D and is transmitted through the sixth transistor T6 to a point G, and the initialization voltage Vref is transmitted through the seventh transistor T7 to the second electrode of the second capacitor C2. Therefore, a voltage of the first electrode of the first capacitor C1 is Vcom, a voltage of the second electrode of the first capacitor is VDD, a voltage of the first electrode of the second capacitor C2 is VDD, a voltage of the second electrode of the second capacitor is Vref, and voltages of the first electrode and the gate of the first transistor T1 are both VDD, thereby implementing initialization of the first capacitor C1, the second capacitor C2, and the light-emitting diode D1.

In the compensation phase t2, the third scan signal S3 is at an on level, such as a high level. The first light-emission control signal EM1 is at an off level, such as a low level. The second light-emission control signal EM2 is at an on level, such as a high level. Therefore, the fifth transistor T5, the sixth transistor T6, and the seventh transistor T7 are turned on. The gate and the first electrode of the first transistor T1 are shorted to form a diode structure, a discharge path is formed between the point D and the seventh transistor T7, and when a voltage at the point D drops to Vref+Vth1, the first transistor T1 is turned off, where Vth1 is a threshold voltage of the first transistor T1 (that is, the threshold voltage Vth of the driver module 110). In this case, a voltage of the gate (the point G) of the first transistor T1 is also Vref+Vth1, and the initialization voltage Vref can be transmitted to the gate of the first transistor T1 while threshold compensation is implemented, to initialize the gate of the first transistor T1. In addition, in the compensation phase t2, a voltage of the first electrode of the light-emitting diode D1 is kept at the initialization voltage Vref, to prevent the light-emitting diode D1 from emitting light. The second capacitor C2 stores the voltage of the gate of the first transistor T1.

In the data writing phase t3, the third scan signal S3 is at an on level, such as a high level. The first light-emission control signal EM1 is at an off level, such as a low level. The second light-emission control signal EM2 is at an off level, such as a low level. Therefore, the sixth transistor T6 and the seventh transistor T7 are turned on. The signal supply terminal supplies the data voltage Vdata to the first electrode of the first capacitor C1, the voltage of the first electrode of the first capacitor C1 jumps from the fixed voltage Vcom to the data voltage Vdata, and a change amount of the voltage of the first electrode of the first capacitor C1 is Vdata-Vcom. Because the sixth transistor T6 is in an on state, under the coupling action of the first capacitor C1, the voltage of the gate of the first transistor T1 is changed to Vref+Vth+c1 (Vdata-Vcom)/(c1+c2+cgs) and is stored in the second capacitor C2, and under the holding action of the seventh transistor T7, the voltage of the second electrode of the second capacitor C2 is kept at the initialization voltage Vref. A voltage difference between two terminals of the second capacitor C2 is Vth1+c1(Vdata−Vcom)/(c1+c2+cgs).

When the third scan signal S3 jumps from the on level to an off level, a coupling action is performed on the gate of the first transistor T1, to pull down the voltage of the gate of the first transistor T1, keeping the gate of the first transistor T1 at a low potential, without causing a threshold compensation loss, and a loss of the voltage of the gate of the driver transistor caused by potential coupling is avoided.

In the light-emission phase t4, the third scan signal S3 is at an off level, such as a low level. The first light-emission control signal EM1 is at an on level, such as a high level. The second light-emission control signal EM2 is at an on level, such as a high level. Therefore, the fourth transistor T4 and the fifth transistor T5 are turned on. The first supply voltage VDD is transmitted to the point D through the fourth transistor T4. Because the sixth transistor T6 is in an off state, the voltage of the gate of the first transistor T1 does not change, and the first transistor T1 generates a drive current I based on the voltages of the gate of the first transistor and the point D, to drive the light-emitting diode D1 to emit light. The drive current I can be expressed as:

$$\begin{matrix}I = \frac{1}{2} μ {C}_{ox} \frac{W}{L} {( Vgs - Vth 1 )}^{2} \\ = \frac{1}{2} μ {C}_{ox} {\frac{W}{L} [ Vth 1 + c 1 ( Vdata - Vcom ) / ( c 1 + c 2 + cgs ) - Vth 1 ]}^{2} \\ = \frac{1}{2} μ {C}_{ox} {\frac{{W}^{2}}{L} [ c 1 ( Vdata - Vcom ) / ( c 1 + c 2 + cgs ) ]}^{2}\end{matrix} .$$

where μ is an electron mobility of the first transistor T1, Cox is a channel capacitance per unit area of the first transistor T1, W/L is a width-to-length ratio of the first transistor T1, Vth1 is the threshold voltage of the first transistor T1, c1 is a capacitance value of the first capacitor C1, c2 is a capacitance value of the second capacitor C2, and cgs is a capacitance value of a parasitic capacitor between the gate and the second electrode of the first transistor T1.

It can be learned from the formula of the drive current I that the drive current I is independent of the first supply voltage VDD, a second supply voltage VSS, and the threshold voltage Vth1 of the first transistor T1. Therefore, the pixel circuit provided in this embodiment can compensate for display unevenness caused by a voltage drop (IR drop) of the threshold voltage of the first transistor T1, the first supply voltage VDD, the second supply voltage VSS, and the like, thereby improving display quality. In addition, because a start time of the data writing phase t3 is later than an end time of the compensation phase t2, the data writing phase t3 and the compensation phase t2 can be completely separated, and the compensation phase t2 and the data writing phase t3 do not affect each other. In this way, the time of the threshold compensation is not limited by a line time, thereby facilitating improvement of a compensation effect.

In one embodiment, during display, a display panel can perform display at a low refresh rate or a high refresh rate. The low refresh rate is achieved through frame skip on the basis of the high refresh rate. A display period includes a write frame and a hold frame. For example, at a refresh rate of 120 Hz, 120 data frames are all write frames, and data writing is performed in each write frame. At a refresh rate of 1 Hz, based on 120 Hz, one data frame is used as a write frame, and the other data frames are used as hold frames. Data writing is performed only in the write frame, and is not performed in the hold frame, and the pixel circuit can be applicable to low frequency driving.

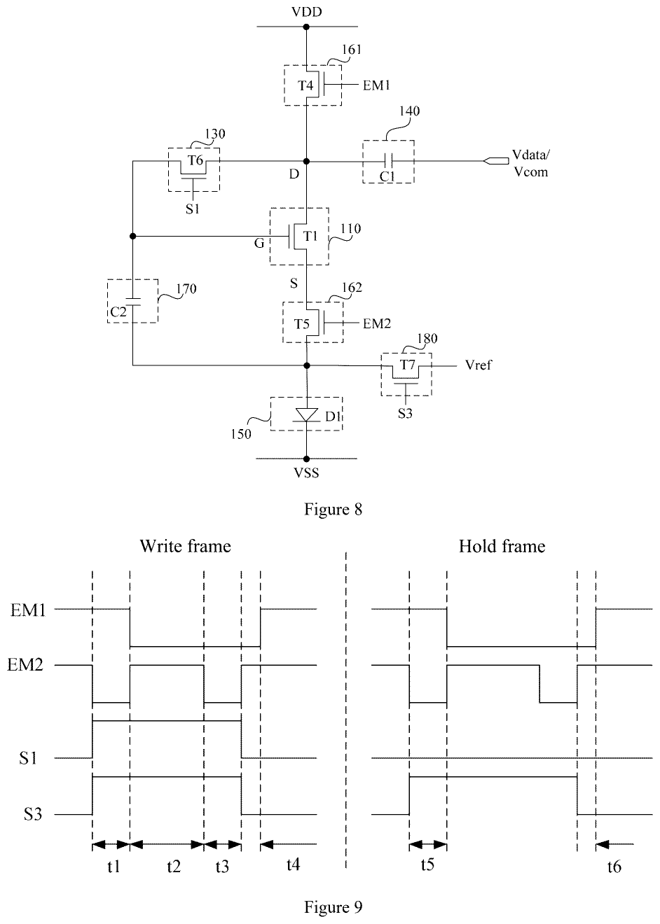

FIG. 8 is a schematic diagram of a structure of another pixel circuit according to an embodiment of the present application, which differs from the pixel circuit shown in FIG. 6 in that the gate of the sixth transistor T6 is connected to a different signal line. With reference to FIG. 8, the gate of the sixth transistor T6 is connected to a first scan line, to receive a first scan signal S1 output from the first scan line. The sixth transistor T6 and the seventh transistor T7 are configured to be connected to different signal lines, and the pixel circuit can operate at a low frequency, and high frequency resetting of the first electrode of the light-emitting diode D1 can be achieved, thereby mitigating low frequency flicker.

FIG. 9 is a schematic diagram of driving timing of another pixel circuit according to an embodiment of the present application, applicable to the pixel circuit shown in FIG. 8. With reference to FIG. 8 and FIG. 9, an operating process of the pixel circuit provided in this embodiment includes the following:

In the write frame, in the initialization phase t1, the first scan signal S1 is at an on level, such as a high level. The third scan signal S3 is at an on level, such as a high level. The first light-emission control signal EM1 is at an on level, such as a high level. The second light-emission control signal EM2 is at an off level, such as a low level. This is the same as the operating process of the initialization phase t1 in the driving timing shown in FIG. 7.

In the compensation phase t2, the first scan signal S1 is at an on level, such as a high level. The third scan signal S3 is at an on level, such as a high level. The first light-emission control signal EM1 is at an off level, such as a low level. The second light-emission control signal EM2 is at an on level, such as a high level. Therefore, the fifth transistor T5, the sixth transistor T6, and the seventh transistor T7 are turned on. This is the same as the operating process of the compensation phase t2 in the driving timing shown in FIG. 7.

In the data writing phase t3, the first scan signal S1 is at an on level, such as a high level. The third scan signal S3 is at an on level, such as a high level. The first light-emission control signal EM1 is at an off level, such as a low level. The second light-emission control signal EM2 is at an off level, such as a low level. This is the same as the operating process of the data writing phase t3 in the driving timing shown in FIG. 7.

In the light-emission phase t4, the first scan signal S1 is at an off level, such as a low level. The third scan signal S3 is at an off level, such as a low level. The first light-emission control signal EM1 is at an on level, such as a high level. The second light-emission control signal EM2 is at an on level, such as a high level. This is the same as the operating process of the light-emission phase t4 in the driving timing shown in FIG. 7.

In the hold frame, the first scan signal S1 is kept at an off level, and the sixth transistor T6 is always in an off state. In an initialization phase t5 in the hold frame, the first scan signal S1 is at an off level, such as a low level. The third scan signal S3 is at an on level, such as a high level. The first light-emission control signal EM1 is at an on level, such as a high level. The second light-emission control signal EM2 is at an off level, such as a low level. Therefore, the fourth transistor T4 and the seventh transistor T7 are turned on. The first supply voltage VDD is transmitted through the fourth transistor T4 to the point D, and the initialization voltage Vref is transmitted through the seventh transistor T7 to the second electrode of the second capacitor C2 and the first electrode of the light-emitting diode D1, to initialize of the first electrode of the light-emitting diode D1. In this process, the signal supply terminal can supply the fixed voltage Vcom to the first electrode of the first capacitor C1.

The operating process of a light-emission phase t6 in the hold frame is the same as that in the light-emission phase t4 in the write frame.

The pixel circuit provided in this embodiment also has the beneficial effects described in any of the above embodiments.

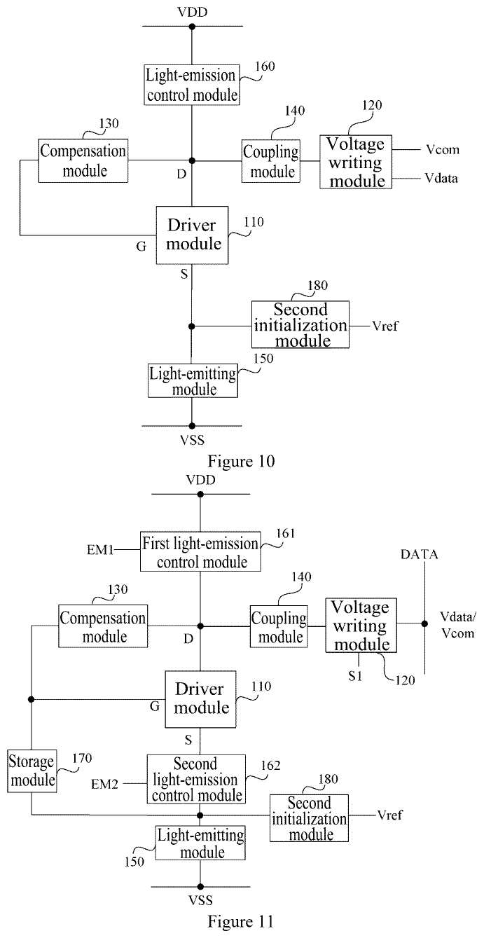

In another implementation of the present application, the fixed voltage Vcom and the data voltage Vdata supplied by the signal supply terminal may be supplied by a specific module and/or a power line. FIG. 10 is a schematic diagram of a structure of another pixel circuit according to an embodiment of the present application. With reference to FIG. 10, the pixel circuit provided in this embodiment includes a driver module 110, a voltage writing module 120, a compensation module 130, and a coupling module 140. The compensation module 130 is connected between a control terminal G and a first terminal D of the driver module 110, and the compensation module 130 is configured to compensate for a threshold voltage Vth of the driver module 110. The coupling module 140 is connected between the first terminal D of the driver module 110 and the voltage writing module 120. The voltage writing module 120 is configured to output a fixed voltage Vcom to the coupling module 140 and output a data voltage Vdata to the coupling module 140. The coupling module 140 is configured to couple a voltage containing information about the data voltage Vdata to the control terminal G of the driver module 110 via the compensation module 130.

Specifically, the driver module 110 and a light-emitting module 150 are connected between a first supply voltage terminal and a second supply voltage terminal, and the driver module 110 is configured to drive the light-emitting module 150 to emit light in a light-emission phase. The first supply voltage terminal is configured to be connected to a first supply voltage VDD, and the second supply voltage terminal is configured to be connected to a second supply voltage VSS. The first supply voltage VDD may be a positive voltage, and the second supply voltage VSS may be a negative voltage.

Using the pixel circuit shown in FIG. 10 as an example, an operating process of the pixel circuit includes at least an initialization phase, a compensation phase, a data writing phase, and a light-emission phase.

In the initialization phase, the compensation module 130 is controlled to be turned on, the first supply voltage VDD initializes the first terminal D and the control terminal G of the driver module 110; at the same time, the voltage writing module 120 transmits the fixed voltage Vcom to a first terminal of the coupling module 140, to initialize the first terminal of the coupling module 140. The first supply voltage VDD is a voltage that can turn on the driver module 110.

In the compensation phase, the compensation module 130 is controlled to be continuously on, the compensation module 130 connects the control terminal G and the first terminal D of the driver module 110, the driver module 110 generates, under the action of the first supply voltage VDD, a current flowing from the first terminal D of the driver module to a second terminal S, and when a voltage difference between the control terminal G and the second terminal S of the driver module 110 is equal to the threshold voltage Vth of the driver module 110, the driver module 110 is turned off. Therefore, a voltage of the control terminal G of the driver module 110 is a voltage associated with the threshold voltage Vth of the driver module, thereby implementing threshold compensation for the driver module 110. In this process, the voltage writing module 120 still transmits the fixed voltage Vcom.

In the data writing phase, the voltage writing module 120 is controlled to transmit the data voltage Vdata to the first terminal of the coupling module 140, the voltage of the first terminal of the coupling module 140 jumps from the fixed voltage Vcom to the data voltage Vdata, and the coupling module couples a voltage associated with the data voltage Vdata to the control terminal G of the driver module 110 via the compensation module 130, and the voltage of the control terminal G of the driver module 110 is associated with the data voltage Vdata.

In the light-emission phase, the driver module 110 generates a drive current based on the voltage of the control terminal G of the driver module, to drive the light-emitting module 150 to emit light.

In the embodiment of the present application, the compensation module is disposed between the control terminal and the first terminal of the driver module, the compensation module is controlled to be turned on in the compensation phase, the first supply voltage of the first supply voltage terminal is transmitted to the control terminal of the driver module to turn on the driver module, and the compensation module compensates for the threshold voltage of the driver module based on the voltage of the first terminal of the driver module. In the data writing phase, the first terminal of the coupling module is controlled to jump from the fixed voltage to the data voltage, and the coupling module couples the data voltage to the control terminal of the driver module, to write the data voltage. In this embodiment, threshold compensation and data writing for the driver module are performed at different times, and the threshold compensation is performed before the data voltage is written into the control terminal of the driver module, and the threshold compensation phase and the data writing phase do not affect each other. In this way, the time of the threshold compensation is not affected by the data writing phase. Even at a high refresh rate, the threshold voltage of the driver module can be fully compensated, and variations in driver module characteristics corresponding to different pixels can be reduced, thereby facilitating the mitigation of variations in display brightness and the enhancement of uniformity of display quality.

In one embodiment, with continued reference to FIG. 10, the pixel circuit provided in this embodiment further includes a second initialization module 180. The second initialization module 180 is connected to a first terminal of the light-emitting module 150, and is configured to initialize a potential of the first terminal of the light-emitting module 150. In the compensation phase, the second initialization module 180 is controlled to be turned on, and the voltage of the first terminal D of the driver module 110 is discharged via the driver module 110 and the second initialization module 180, thereby implementing threshold compensation for the driver module 110.

In one embodiment, with continued reference to FIG. 10, the pixel circuit provided in this embodiment further includes a light-emission control module 160, and the light-emission control module 160, the driver module 110, and the light-emitting module 150 are connected between a first supply voltage terminal and a second supply voltage terminal. The light-emission control module 160 may be configured to break a connection between the first terminal D of the driver module 110 and the first supply voltage terminal in the compensation phase, and the voltage of the first terminal D of the driver module 110 can be discharged via the driver module 110 and the second initialization module 180. Certainly, in other embodiments, the light-emission control module 160 may not be disposed between the first terminal D of the driver module 110 and the first supply voltage terminal, and the voltage of the first terminal D of the driver module 110 can be controlled by controlling whether the first supply voltage terminal is connected to the first supply voltage, to achieve the same effect.

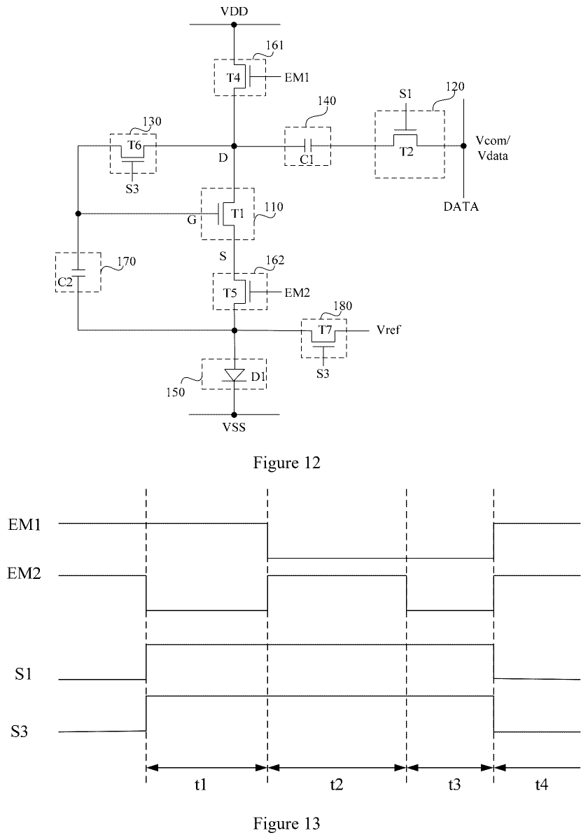

FIG. 11 is a schematic diagram of a structure of another pixel circuit according to an embodiment of the present application. With reference to FIG. 11, in one embodiment, on the basis of the above-described embodiments, the pixel circuit provided in this embodiment further includes a first light-emission control module 161 and a second light-emission control module 162. The first light-emission control module 161 is connected between the first supply voltage terminal and the first terminal D of the driver module 110, the second light-emission control module 162 is connected between the second terminal S of the driver module 110 and the first terminal of the light-emitting module 150, and a second terminal of the light-emitting module 150 is connected to the second supply voltage terminal. A control terminal of the first light-emission control module 161 is connected to a first light-emission control signal line, and a control terminal of the second light-emission control module 162 is connected to a second light-emission control signal line. The first light-emission control module 161 is configured to, in response to a first light-emission control signal EM1 on the first light-emission control signal line, be turned on at least in the light-emission phase and be turned off in the compensation phase and the data writing phase. The second light-emission control module 162 is configured to, in response to a second light-emission control signal EM2 on the second light-emission control signal line, be turned on at least in the compensation phase and the light-emission phase.

With continued reference to FIG. 11, a control terminal of the voltage writing module 120 is connected to a first scan line, a first terminal of the voltage writing module 120 is connected to a data line DATA, a second terminal of the voltage writing module 120 is connected to a first terminal of the coupling module 140, and a second terminal of the coupling module 140 is connected to the first terminal D of the driver module 110. The data line DATA is configured to transmit the fixed voltage Vcom at least in a compensation phase and transmit the data voltage Vdata in a data writing phase. For example, in the initialization phase, the voltage writing module 120 is turned on in response to a first scan signal S1 transmitted on the first scan line, and outputs the fixed voltage Vcom transmitted on the data line DATA to the first terminal of the coupling module 140; at the same time, the first supply voltage VDD is transmitted to the second terminal of the coupling module 140 (that is, the first terminal D of the driver module 110), to keep a stable voltage across two terminals of the coupling module 140. In the initialization phase, the first supply voltage VDD is further transmitted through the turned-on compensation module 130 to the control terminal of the driver module 110, to turn on the driver module 110, to compensate for the threshold voltage of the driver module 110 in the compensation phase.

In the compensation phase, the data line DATA still transmits the fixed voltage Vcom, and the compensation module 130 compensates for the threshold voltage Vth of the driver module 110 based on a voltage present after the first terminal D of the driver module 110 discharges.

In the data writing phase, the voltage transmitted on the data line DATA is changed to the data voltage Vdata, and the voltage writing module 120 is kept on in response to the first scan signal S1 transmitted on the first scan line, and outputs the data voltage Vdata transmitted on the data line DATA to the first terminal of the coupling module 140. The voltage of the first terminal of the coupling module 140 jumps, and under the coupling action of the coupling module 140, a difference between the data voltage Vdata and the fixed voltage Vcom is coupled to the control terminal G of the driver module 110, to write the data voltage Vdata into the control terminal G of the driver module 110.

In this embodiment, the data line DATA is reused for time-division transmission of the fixed voltage Vcom and the data voltage Vdata, and the data voltage Vdata can be written into the control terminal G of the driver module 110 in the data writing phase. This facilitates the reduction of a quantity of signal lines, to achieve high PPI (Pixels Per Inch, pixel density).

In one embodiment, with continued reference to FIG. 11, the pixel circuit further includes a storage module 170 connected between the control terminal G of the driver module 110 and the first terminal of the light-emitting module 150. The second light-emission control module 162 is further configured to be turned off in the data writing phase in response to the second light-emission control signal EM2, to improve charging efficiency of the driver module 110. A specific operating principle of the second light-emission control module is described in detail in the subsequent embodiments.

In an optional implementation of this embodiment, a control terminal of the compensation module 130 and a control terminal of the second initialization module 180 may be connected to a same scan line. FIG. 12 is a schematic diagram of a structure of another pixel circuit according to an embodiment of the present application, and is specifically a schematic diagram of a structure of the pixel circuit shown in FIG. 11 that is detailed as devices. With reference to FIG. 12, in one embodiment, the driver module 110 includes a first transistor T1, a first electrode of the first transistor T1 is the first terminal D of the driver module 110, a second electrode of the first transistor T1 is the second terminal S of the driver module 110, a gate of the first transistor T1 is the control terminal G of the driver module 110, the data writing module 120 includes a second transistor T2, the coupling module 140 includes a first capacitor C1, a gate of the second transistor T2 is connected to a first scan line, a first electrode of the second transistor T2 is connected to a data line DATA, a second electrode of the second transistor T2 is connected to a first electrode of the first capacitor C1, and a second electrode of the first capacitor C1 is connected to the first electrode of the first transistor T1.

The first light-emission control module 161 includes a fourth transistor T4, the second light-emission control module 162 includes a fifth transistor T5, and the light-emitting module 150 includes a light-emitting diode D1. A gate of the fourth transistor T4 is connected to the first light-emission control signal line, a first electrode of the fourth transistor T4 is connected to the first supply voltage terminal, a second electrode of the fourth transistor T4 is connected to the first terminal D of the driver module 110, the second terminal of the driver module 110 is connected to a first electrode of the fifth transistor T5, a second electrode of the fifth transistor T5 is connected to a first electrode of the light-emitting diode D1, a second electrode of the light-emitting diode D1 is connected to the second supply voltage terminal, and a gate of the fifth transistor T5 is connected to the second light-emission control signal line.

The storage module 170 includes a second capacitor C2, a first electrode of the second capacitor C2 is connected to the control terminal G of the driver module 110, and a second electrode of the second capacitor C2 is connected to the first terminal of the light-emitting module 150.

In one embodiment, the control terminal of the compensation module 130 is connected to a third scan line, and a sixth transistor T6 included in the compensation module 130 is kept on in the initialization phase, the compensation phase, and the data writing phase in response to a third scan signal S3 transmitted on the third scan line.

The control terminal of the second initialization module 180 may also be connected to the third scan line, and may be turned on simultaneously with the compensation module 130. A first terminal of the second initialization module 180 is connected to an initialization signal line, the initialization signal line is configured to transmit an initialization voltage Vref, a second terminal of the second initialization module 180 is connected to the first terminal of the light-emitting module 150, and the second initialization module 180 is configured to transmit the initialization voltage Vref on the initialization signal line to the first terminal of the light-emitting module 150 in the initialization phase. The second initialization module 180 includes a seventh transistor T7, a gate of the sixth transistor T6 and a gate of the seventh transistor T7 are both connected to the third scan line, a first electrode of the sixth transistor T6 is connected to the first terminal D of the driver module 110, a second electrode of the sixth transistor T6 is connected to the control terminal G of the driver module 110, a first electrode of the seventh transistor T7 is connected to the initialization signal line, and a second electrode of the seventh transistor T7 is connected to the first terminal of the light-emitting module 150.

FIG. 13 is a schematic diagram of driving timing of another pixel circuit according to an embodiment of the present application, applicable to the pixel circuit shown in FIG. 12. A specific operating process of the pixel circuit provided in this embodiment of the present application is described by using an example in which each transistor shown in FIG. 12 is an N-type transistor. With reference to FIG. 12 and FIG. 13, the operating process of the pixel circuit provided in this embodiment includes an initialization phase t1, a compensation phase t2, a data writing phase t3, and a light-emission phase t4.

In the initialization phase t1, the first scan signal S1 is at an on level, such as a high level. The third scan signal S3 is at an on level, such as a high level. The first light-emission control signal EM1 is at an on level, such as a high level. The second light-emission control signal EM2 is at an off level, such as a low level. Therefore, the second transistor T2, the fourth transistor T4, the sixth transistor T6, and the seventh transistor T7 are turned on. The fixed voltage Vcom transmitted on the data line DATA is transmitted through the second transistor T2 to the first electrode of the first capacitor C1, the first supply voltage VDD is transmitted through the fourth transistor T4 to a point D and is transmitted through the sixth transistor T6 to a point G, and the initialization voltage Vref is transmitted through the seventh transistor T7 to the second electrode of the second capacitor C2. Therefore, a voltage of the first electrode of the first capacitor C1 is Vcom, a voltage of the second electrode of the first capacitor is VDD, a voltage of the first electrode of the second capacitor C2 is VDD, a voltage of the second electrode of the second capacitor is Vref, voltages of the first electrode and the gate of the first transistor T1 are both VDD, and the first transistor T1 is turned on.

In the compensation phase t2, the first scan signal S1 is at an on level, such as a high level. The third scan signal S3 is at an on level, such as a high level. The first light-emission control signal EM1 is at an off level, such as a low level. The second light-emission control signal EM2 is at an on level, such as a high level. Therefore, the second transistor T2, the fifth transistor T5, the sixth transistor T6, and the seventh transistor T7 are turned on. The gate and the first electrode of the first transistor T1 are shorted to form a diode structure, a discharge path is formed between the point D and the seventh transistor T7, and when a voltage at the point D drops to Vref+Vth1, the first transistor T1 is turned off, where Vth1 is a threshold voltage of the first transistor T1. In this case, a voltage of the gate (the point G) of the first transistor T1 is also Vref+Vth1, and the initialization voltage Vref can be transmitted to the gate of the first transistor T1 while threshold compensation is implemented, to initialize the gate of the first transistor T1. In addition, in the compensation phase t2, a voltage of the first electrode of the light-emitting diode D1 is kept at the initialization voltage Vref, to prevent the light-emitting diode D1 from emitting light. The second capacitor C2 stores the voltage of the gate of the first transistor T1.

In the data writing phase t3, the first scan signal S1 is at an on level, such as a high level. The third scan signal S3 is at an on level, such as a high level. The first light-emission control signal EM1 is at an off level, such as a low level. The second light-emission control signal EM2 is at an off level, such as a low level. Therefore, the second transistor T2, the sixth transistor T6, and the seventh transistor T7 are turned on. The data voltage Vdata on the data line DATA is transmitted through the second transistor T2 to the first electrode of the first capacitor C1, the voltage of the first electrode of the first capacitor C1 jumps from the fixed voltage Vcom to the data voltage Vdata, and a change amount of the voltage of the first electrode of the first capacitor C1 is Vdata-Vcom. Because the sixth transistor T6 is in an on state, under the coupling action of the first capacitor C1, the voltage of the gate of the first transistor T1 is changed to Vref+Vth1+c1 (Vdata−Vcom)/(c1+c2+cgs) and is stored in the second capacitor C2, and under the holding action of the seventh transistor T7, the voltage of the second electrode of the second capacitor C2 is kept at the initialization voltage Vref. A voltage difference between two terminals of the second capacitor C2 is Vth1+c1(Vdata−Vcom)/(c1+c2+cgs). c1 is a capacitance value of the first capacitor C1, c2 is a capacitance value of the second capacitor C2, and cgs is a capacitance value of a parasitic capacitor between the gate and the second electrode of the first transistor T1.

In addition, in the data writing phase t3, because the fifth transistor T5 included in the second light-emission control module 162 is in an off state, the first capacitor C1 and the second capacitor C2 are of a series structure. This improves charging efficiency of the first transistor T1 in the data writing phase, to ensure display quality of the pixel circuit at a high frequency.

In the light-emission phase t4, the first scan signal S1 is at an off level, such as a low level. The third scan signal S3 is at an off level, such as a low level. The first light-emission control signal EM1 is at an on level, such as a high level. The second light-emission control signal EM2 is at an on level, such as a high level. Therefore, the fourth transistor T4 and the fifth transistor T5 are turned on. The first supply voltage VDD is transmitted to the point D through the fourth transistor T4. Because the sixth transistor T6 is kept in an off state, the voltage of the gate of the first transistor T1 does not change, and the first transistor T1 generates a drive current I based on the voltages of the gate of the first transistor and the point D, to drive the light-emitting diode D1 to emit light. The drive current I can be expressed as:

$$\begin{matrix}I = \frac{1}{2} μ {C}_{ox} \frac{W}{L} {( Vgs - Vth 1 )}^{2} \\ = \frac{1}{2} μ {C}_{ox} {\frac{W}{L} [ Vth 1 + c 1 ( Vdata - Vcom ) / ( c 1 + c 2 + cgs ) - Vth 1 ]}^{2} \\ = \frac{1}{2} μ {C}_{ox} {\frac{{W}^{2}}{L} [ c 1 ( Vdata - Vcom ) / ( c 1 + c 2 + cgs ) ]}^{2}\end{matrix} .$$

where μ is an electron mobility of the first transistor T1, Cox is a channel capacitance per unit area of the first transistor T1, W/L is a width-to-length ratio of the first transistor T1, and Vth1 is the threshold voltage of the first transistor T1.

It can be learned from the formula of the drive current I that the drive current I is independent of the first supply voltage VDD, a second supply voltage VSS, and the threshold voltage Vth1 of the first transistor T1. Therefore, the pixel circuit provided in this embodiment can compensate for display unevenness caused by a voltage drop (IR drop) of the threshold voltage Vth1 of the first transistor T1, the first supply voltage VDD, the second supply voltage VSS, and the like, thereby improving display quality.

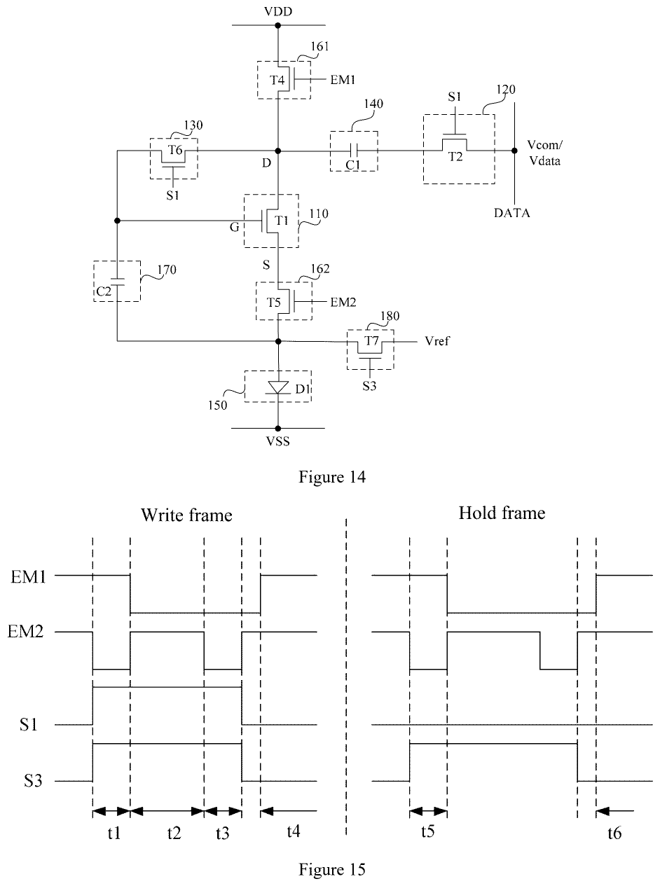

FIG. 14 is a schematic diagram of a structure of another pixel circuit according to an embodiment of the present application. The control terminal of the compensation module 130 and the control terminal of the voltage writing module 120 may be connected to a same first scan line, and the control terminal of the second initialization module 180 is connected to a third scan line, to satisfy a display effect of the pixel circuit under low frequency driving.

FIG. 15 is a schematic diagram of driving timing of another pixel circuit according to an embodiment of the present application, applicable to the pixel circuit shown in FIG. 14. With reference to FIG. 14 and FIG. 15, in the write frame, the driving timing shown in FIG. 15 is the same as the driving timing shown in FIG. 13, and details are not described again.

In the hold frame, the first scan signal S1 is kept at an off level, and the second transistor T2 and the sixth transistor T6 are always in an off state. In an initialization phase t5 in the hold frame, the first scan signal S1 is at an off level, such as a low level. The third scan signal S3 is at an off level, such as a low level. The first light-emission control signal EM1 is at an on level, such as a high level. The second light-emission control signal EM2 is at an off level, such as a low level. Therefore, the fourth transistor T4 and the seventh transistor T7 are turned on. The first supply voltage VDD is transmitted through the fourth transistor T4 to the point D, and the initialization voltage Vref is transmitted through the seventh transistor T7 to the second electrode of the second capacitor C2 and the first electrode of the light-emitting diode D1, to achieve high frequency resetting of the first electrode of the light-emitting diode D1, thereby mitigating flicker of the light-emitting diode D1.

The operating process of a light-emission phase t6 in the hold frame is the same as that in the light-emission phase t4 in the write frame.

The pixel circuit provided in this embodiment also has the beneficial effects described in any of the above embodiments.

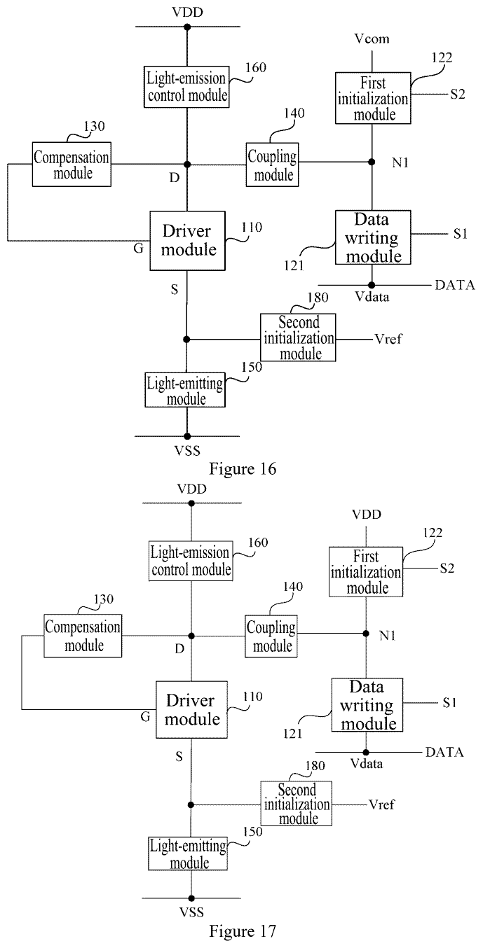

In another optional implementation of the present application, the data voltage Vdata and the fixed voltage Vcom can be transmitted using different signal lines, to prevent interference between the two. FIG. 16 is a schematic diagram of a structure of another pixel circuit according to an embodiment of the present application. With reference to FIG. 16, the pixel circuit provided in this embodiment includes a driver module 110, a data writing module 121, a first initialization module 122, a compensation module 130, and a coupling module 140. The compensation module 130 is connected between a control terminal G and a first terminal D of the driver module 110, and the compensation module 130 is configured to compensate for a threshold voltage Vth of the driver module 110. The data writing module 121 and the first initialization module 122 are connected at a first node N1. The coupling module 140 is connected between the first terminal D of the driver module 110 and the first node N1, the first initialization module 122 is configured to transmit a fixed voltage Vcom to the coupling module 140, and the coupling module 140 is configured to couple, to the control terminal G of the driver module 110 via the compensation module 130, a voltage transmitted by the data writing module 121 and containing information about a data voltage Vdata.

A first terminal of the first initialization module 122 is connected to the fixed voltage Vcom, a second terminal of the first initialization module 122 is connected to a first terminal of the coupling module 140, a second terminal of the coupling module 140 is connected to the first terminal of the driver module 110, the first terminal of the coupling module 140 is further connected to a second terminal of the data writing module 121, a first terminal of the data writing module 121 is connected to a data line DATA, a control terminal of the data writing module 121 is connected to a first scan line, a control terminal of the first initialization module 122 is connected to a second scan line, and the first initialization module 122 is configured to transmit the fixed voltage Vcom to the first terminal of the coupling module 140 in an initialization phase. The compensation module 130 is further configured to transmit a first supply voltage VDD of a first supply voltage terminal to the control terminal G of the driver module 110 in the initialization phase. The first scan line is configured to transmit a first scan signal S1, and the second scan line is configured to transmit a second scan signal S2. Here, the fixed voltage Vcom may be supplied by a power line, and the data line DATA is configured to transmit only the data voltage Vdata, and transmit the data voltage Vdata at least in a data writing phase.

FIG. 17 is a schematic diagram of a structure of another pixel circuit according to an embodiment of the present application. With reference to FIG. 17, on the basis of the above-described embodiments, the first supply voltage VDD to which the first supply voltage terminal is connected is the same as the fixed voltage Vcom. To be specific, the first terminal of the first initialization module 122 is connected to the first supply voltage terminal, and the first supply voltage VDD is reused as the fixed voltage Vcom, and a quantity of power lines can be reduced.

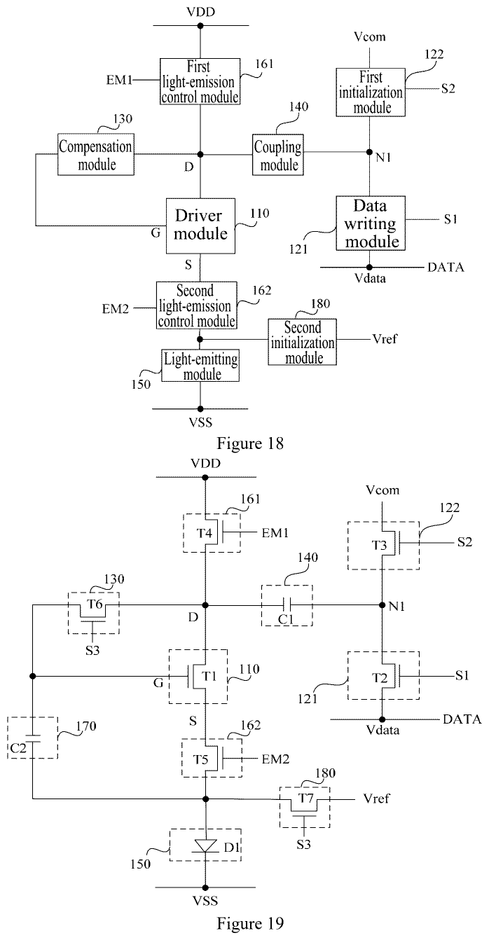

FIG. 18 is a schematic diagram of a structure of another pixel circuit according to an embodiment of the present application. With reference to FIG. 18, on the basis of the above-described embodiments, the pixel circuit provided in this embodiment further includes a first light-emission control module 161 and a second light-emission control module 162. The first light-emission control module 161 is connected between the first supply voltage terminal and the first terminal D of the driver module 110, the second light-emission control module 162 is connected between the second terminal S of the driver module 110 and the first terminal of the light-emitting module 150, and a second terminal of the light-emitting module 150 is connected to the second supply voltage terminal. A control terminal of the first light-emission control module 161 is connected to a first light-emission control signal line, and a control terminal of the second light-emission control module 162 is connected to a second light-emission control signal line. The first light-emission control module 161 is configured to, in response to a first light-emission control signal EM1 on the first light-emission control signal line, be turned on at least in the light-emission phase and be turned off in the compensation phase and the data writing phase. The second light-emission control module 162 is configured to, in response to a second light-emission control signal EM2 on the second light-emission control signal line, be turned on at least in the compensation phase and the light-emission phase.

Specifically, in the initialization phase, the first initialization module 122 is turned on in response to the second scan signal S2, the data writing module 121 is turned off in response to the first scan signal S1, and the fixed voltage Vcom is transmitted through the first initialization module 122 to the first terminal of the coupling module 140. The first light-emission control module 161 is turned on in response to the first light-emission control signal EM1, the second light-emission control module 162 is turned off in response to the second light-emission control signal EM2, the first supply voltage VDD is transmitted through the first light-emission control module 161 to the first terminal D of the driver module 110, to initialize the coupling module 140. In addition, the compensation module 130 is controlled to be turned on, and the control terminal G and the first terminal D of the driver module 110 are connected, the control terminal G and the first terminal D of the driver module 110 have the same voltage, and the driver module 110 is turned on. In addition, the second initialization module 180 may be further controlled to be turned on, and transmit the initialization voltage Vref to the first terminal of the light-emitting module 150, to initialize the first terminal of the light-emitting module 150.

In the compensation phase, the first initialization module 122 and the compensation module 130 are kept on, the data writing module 121 is turned off in response to the first scan signal S1, the first light-emission control module 161 is turned off in response to the first light-emission control signal EM1, the second light-emission control module 162 is turned on in response to the second light-emission control signal EM2, a discharge path is formed between the first terminal D of the driver module 110 and the second initialization module 180, and when the voltage of the first terminal D of the driver module 110 drops to Vref+Vth, the driver module 110 is turned off, where Vth is the threshold voltage of the driver module 110. In this case, the voltage of the control terminal G of the driver module 110 is also Vref+Vth, and the initialization voltage Vref can be transmitted to the control terminal of the driver module 110 while threshold compensation is implemented, to initialize the control terminal of the driver module 110. In this embodiment, a separate module for initializing the control terminal G of the driver module 110 is not required, thereby reducing a quantity of transistors in the pixel circuit.

In the data writing phase, the first initialization module 122 is turned off in response to the second scan signal S2, the data writing module 121 is turned on in response to the first scan signal S1, both the first light-emission control module 161 and the second light-emission control module 162 are turned off in response to corresponding light-emission control signals, and the compensation module 130 is kept on. The data writing module 121 outputs the data voltage Vdata transmitted on the data line DATA to the first terminal of the coupling module 140, the voltage of the first terminal of the coupling module 140 jumps from the fixed voltage Vcom to the data voltage Vdata, and the coupling module 140 couples a voltage associated with the data voltage Vdata to the control terminal G of the driver module 110 via the compensation module 130, and the voltage of the control terminal G of the driver module 110 is associated with the data voltage Vdata.

In the light-emission phase, both the first light-emission control module 161 and the second light-emission control module 162 are turned on in response to corresponding light-emission control signals, and the driver module 110 generates a drive current based on the voltage of the control terminal G of the driver module, to drive the light-emitting module 150 to emit light.

FIG. 19 is a schematic diagram of a structure of another pixel circuit according to an embodiment of the present application, and is specifically a schematic diagram of a structure of the pixel circuit shown in FIG. 18 that is detailed as devices. With reference to FIG. 19, on the basis of the above-described embodiments, the driver module 110 includes a first transistor T1, a first electrode of the first transistor T1 is the first terminal D of the driver module 110, a second electrode of the first transistor T1 is the second terminal S of the driver module 110, a gate of the first transistor T1 is the control terminal G of the driver module 110, the data writing module 121 includes a second transistor T2, the coupling module 140 includes a first capacitor C1, a gate of the second transistor T2 is connected to a first scan line, a first electrode of the second transistor T2 is connected to a data line DATA, a second electrode of the second transistor T2 is connected to a first electrode of the first capacitor C1, and a second electrode of the first capacitor C1 is connected to the first electrode of the first transistor T1.

The first initialization module 122 includes a third transistor T3, a gate of the third transistor T3 is connected to a second scan line, a first electrode of the third transistor T3 is connected to the fixed voltage Vcom, and a second electrode of the third transistor T3 is connected to the first terminal of the coupling module 140 (that is, connected to the first electrode of the first capacitor C1).

The first light-emission control module 161 includes a fourth transistor T4, the second light-emission control module 162 includes a fifth transistor T5, and the light-emitting module 150 includes a light-emitting diode D1. A gate of the fourth transistor T4 is connected to the first light-emission control signal line, a first electrode of the fourth transistor T4 is connected to the first supply voltage terminal, a second electrode of the fourth transistor T4 is connected to the first terminal D of the driver module 110, the second terminal of the driver module 110 is connected to a first electrode of the fifth transistor T5, a second electrode of the fifth transistor T5 is connected to a first electrode of the light-emitting diode D1, a second electrode of the light-emitting diode D1 is connected to the second supply voltage terminal, and a gate of the fifth transistor T5 is connected to the second light-emission control signal line.

In one embodiment, the pixel circuit further includes a storage module 170 connected between the control terminal G of the driver module 110 and the first terminal of the light-emitting module 150. The second light-emission control module 162 is further configured to be turned off in the data writing phase in response to the second light-emission control signal EM2.

The storage module 170 includes a second capacitor C2, a first electrode of the second capacitor C2 is connected to the control terminal G of the driver module 110, and a second electrode of the second capacitor C2 is connected to the first terminal of the light-emitting module 150.

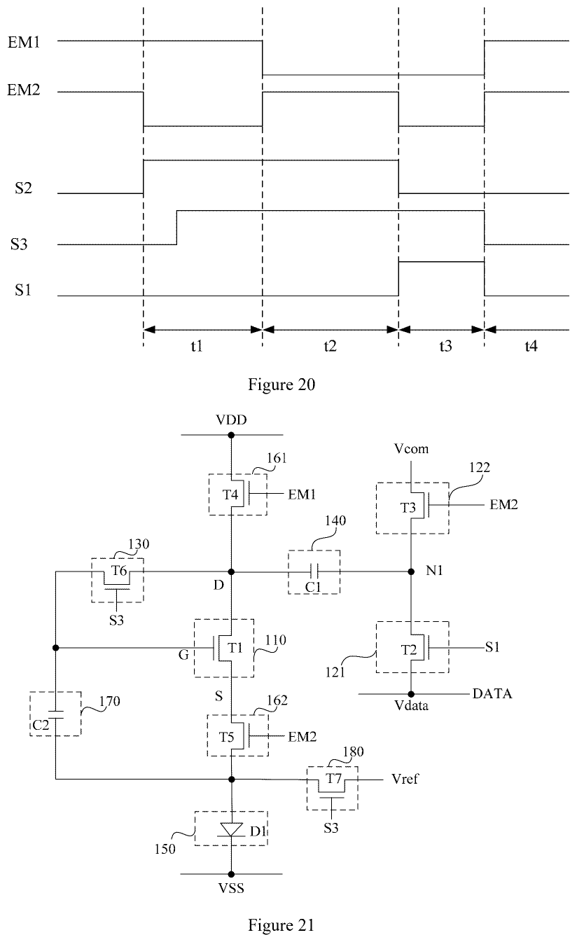

FIG. 20 is a schematic diagram of driving timing of another pixel circuit according to an embodiment of the present application, applicable to the pixel circuit shown in FIG. 19. A specific operating process of the pixel circuit provided in this embodiment of the present application is described by using an example in which each transistor shown in FIG. 19 is an N-type transistor. With reference to FIG. 19 and FIG. 20, the operating process of the pixel circuit provided in this embodiment includes an initialization phase t1, a compensation phase t2, a data writing phase t3, and a light-emission phase t4.

In the initialization phase t1, the first scan signal S1 is at an off level, such as a low level. The second scan signal S2 is at an on level, such as a high level. The third scan signal S3 is at an on level, such as a high level. The first light-emission control signal EM1 is at an on level, such as a high level. The second light-emission control signal EM2 is at an off level, such as a low level. Therefore, the third transistor T3, the fourth transistor T4, the sixth transistor T6, and the seventh transistor T7 are turned on. The fixed voltage Vcom is transmitted through the third transistor T3 to the first electrode of the first capacitor C1, the first supply voltage VDD is transmitted through the fourth transistor T4 to a point D and is transmitted through the sixth transistor T6 to a point G, and the initialization voltage Vref is transmitted through the seventh transistor T7 to the second electrode of the second capacitor C2. Therefore, a voltage of the first electrode of the first capacitor C1 is Vcom, a voltage of the second electrode of the first capacitor is VDD, a voltage of the first electrode of the second capacitor C2 is VDD, a voltage of the second electrode of the second capacitor is Vref, voltages of the first electrode and the gate of the first transistor T1 are both VDD, and the first transistor T1 is turned on.

In the compensation phase t2, the first scan signal S1 is at an off level, such as a low level. The second scan signal S2 is at an on level, such as a high level. The third scan signal S3 is at an on level, such as a high level. The first light-emission control signal EM1 is at an off level, such as a low level. The second light-emission control signal EM2 is at an on level, such as a high level. Therefore, the third transistor T3, the fifth transistor T5, the sixth transistor T6, and the seventh transistor T7 are turned on. The gate and the first electrode of the first transistor T1 are shorted to form a diode structure, a discharge path is formed between the point D and the seventh transistor T7, and when a voltage at the point D drops to Vref+Vth1, the first transistor T1 is turned off, where Vth1 is a threshold voltage of the first transistor T1. In this case, a voltage of the gate (the point G) of the first transistor T1 is also Vref+Vth, and the initialization voltage Vref can be transmitted to the gate of the first transistor T1 while threshold compensation is implemented, to initialize the gate of the first transistor T1. In addition, in the compensation phase t2, a voltage of the first electrode of the light-emitting diode D1 is kept at the initialization voltage Vref, to prevent the light-emitting diode D1 from emitting light. The second capacitor C2 stores the voltage of the gate of the first transistor T1.

In the data writing phase t3, the first scan signal S1 is at an on level, such as a high level. The second scan signal S2 is at an off level, such as a low level. The third scan signal S3 is at an on level, such as a high level. The first light-emission control signal EM1 is at an off level, such as a low level. The second light-emission control signal EM2 is at an off level, such as a low level. Therefore, the second transistor T2, the sixth transistor T6, and the seventh transistor T7 are turned on. The data voltage Vdata on the data line DATA is transmitted through the second transistor T2 to the first electrode of the first capacitor C1, the voltage of the first electrode of the first capacitor C1 jumps from the fixed voltage Vcom to the data voltage Vdata, and a change amount of the voltage of the first electrode of the first capacitor C1 is Vdata-Vcom. Because the sixth transistor T6 is in an on state, under the coupling action of the first capacitor C1, the voltage of the gate of the first transistor T1 is changed to Vref+Vth+c1(Vdata−Vcom)/(c1+c2+cgs) and is stored in the second capacitor C2, and under the holding action of the seventh transistor T7, the voltage of the second electrode of the second capacitor C2 is kept at the initialization voltage Vref. A voltage difference between two terminals of the second capacitor C2 is Vth+c1(Vdata−Vcom)/(c1+c2+cgs).

When the third scan signal S3 jumps from the on level to an off level, a coupling action is performed on the gate of the first transistor T1, to pull down the voltage of the gate of the first transistor T1, keeping the gate of the first transistor T1 at a low potential, without causing a threshold compensation loss, and a loss of the voltage of the gate of the driver transistor caused by potential coupling is avoided.

In the light-emission phase t4, the first scan signal S1 is at an off level, such as a low level. The second scan signal S2 is at an off level, such as a low level. The third scan signal S3 is at an off level, such as a low level. The first light-emission control signal EM1 is at an on level, such as a high level. The second light-emission control signal EM2 is at an on level, such as a high level. Therefore, the fourth transistor T4 and the fifth transistor T5 are turned on. The first supply voltage VDD is transmitted to the point D through the fourth transistor T4. Because the sixth transistor T6 is kept in an off state, the voltage of the gate of the first transistor T1 does not change, and the first transistor T1 generates a drive current I based on the voltages of the gate of the first transistor and the point D, to drive the light-emitting diode D1 to emit light. The drive current I can be expressed as:

$$\begin{matrix}I = \frac{1}{2} μ {C}_{ox} \frac{W}{L} {( Vgs - Vth 1 )}^{2} \\ = \frac{1}{2} μ {C}_{ox} {\frac{W}{L} [ Vth 1 + c 1 ( Vdata - Vcom ) / ( c 1 + c 2 + cgs ) - Vth 1 ]}^{2} \\ = \frac{1}{2} μ {C}_{ox} {\frac{{W}^{2}}{L} [ c 1 ( Vdata - Vcom ) / ( c 1 + c 2 + cgs ) ]}^{2}\end{matrix} .$$

where μ is an electron mobility of the first transistor T1, Cox is a channel capacitance per unit area of the first transistor T1, W/L is a width-to-length ratio of the first transistor T1, Vth1 is the threshold voltage of the first transistor T1, c1 is a capacitance value of the first capacitor C1, c2 is a capacitance value of the second capacitor C2, and cgs is a capacitance value of a parasitic capacitor between the gate and the second electrode of the first transistor T1.

It can be learned from the formula of the drive current I that the drive current I is independent of the first supply voltage VDD, a second supply voltage VSS, and the threshold voltage Vth1 of the first transistor T1. Therefore, the pixel circuit provided in this embodiment can compensate for display unevenness caused by a voltage drop (IR drop) of the threshold voltage Vth1 of the first transistor T1, the first supply voltage VDD, the second supply voltage VSS, and the like, thereby improving display quality.

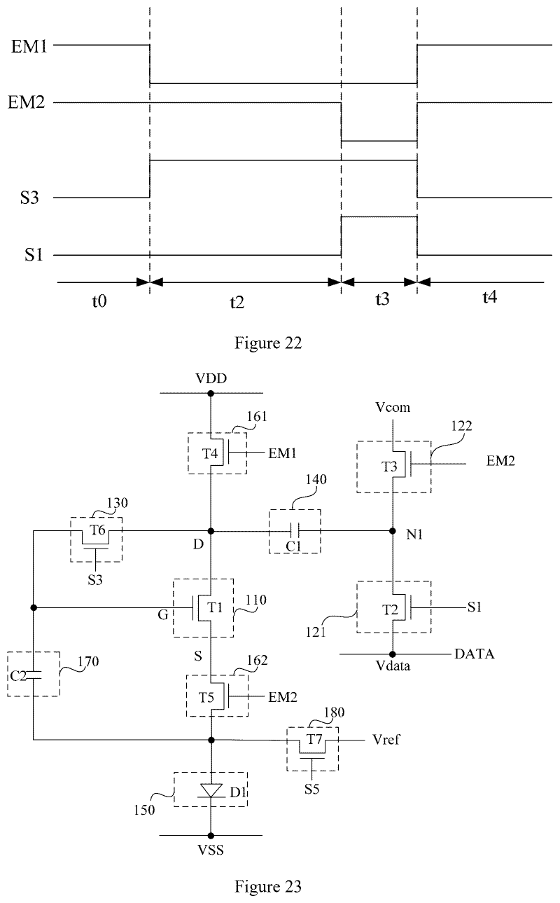

In another optional implementation of this embodiment of the present application, the second light-emission control signal line may be reused as the second scan line connected to the control terminal of the first initialization module 122, to reduce a quantity of signal lines and achieve high PPI. FIG. 21 is a schematic diagram of a structure of another pixel circuit according to an embodiment of the present application. With reference to FIG. 21, both the gate of the third transistor T3 and the gate of the fifth transistor T5 are connected to the second light-emission control signal EM2, and the initialization phase can coincide with the light-emission phase, to increase a threshold compensation time, and ensure that the first transistor T1 can obtain full compensation. FIG. 22 is a schematic diagram of driving timing of another pixel circuit according to an embodiment of the present application, applicable to the pixel circuit shown in FIG. 21. With reference to FIG. 21 and FIG. 22, an operating process of the pixel circuit includes a compensation phase t2, a data writing phase t3, and a light-emission phase t4.

In an initialization phase t0, the light-emitting diode D1 is in a light-emitting state, a voltage of the first electrode of the first capacitor C1 is the fixed voltage Vcom, and a voltage of the second electrode of the first capacitor is the first supply voltage VDD.

The compensation phase t2 and the data writing phase t3 are the same as those in the operating process of the pixel circuit shown in FIG. 19, and details are not described herein again.

In the light-emission phase t4, the first scan signal S1 is at an off level, such as a low level. The third scan signal S3 is at an off level, such as a low level. The first light-emission control signal EM1 is at an on level, such as a high level. The second light-emission control signal EM2 is at an on level, such as a high level. Therefore, the third transistor T3, the fourth transistor T4, and the fifth transistor T5 are turned on. The first supply voltage VDD is transmitted to the point D through the fourth transistor T4, and the first transistor T1 generates a drive current I based on the voltages of the gate of the first transistor and the point D, to drive the light-emitting diode D1 to emit light. In addition, the third transistor T3 transmits the fixed voltage Vcom to the first terminal of the first capacitor C1, to initialize the first capacitor C1.

In this embodiment, when a display panel performs display at a low refresh rate, because neither of a data writing operation and a threshold compensation operation is performed in the hold frame, the seventh transistor T7 and the sixth transistor T6 are in an off state in the hold frame, the first electrode of the light-emitting diode D1 cannot be reset, and the light-emission phase is prone to flicker. To avoid the above situation, and the pixel circuit can be applicable to low frequency driving, the first electrode of the light-emitting diode D1 may be reset separately using another module, or a scan signal to which the gate of the seventh transistor T7 is connected may be changed.

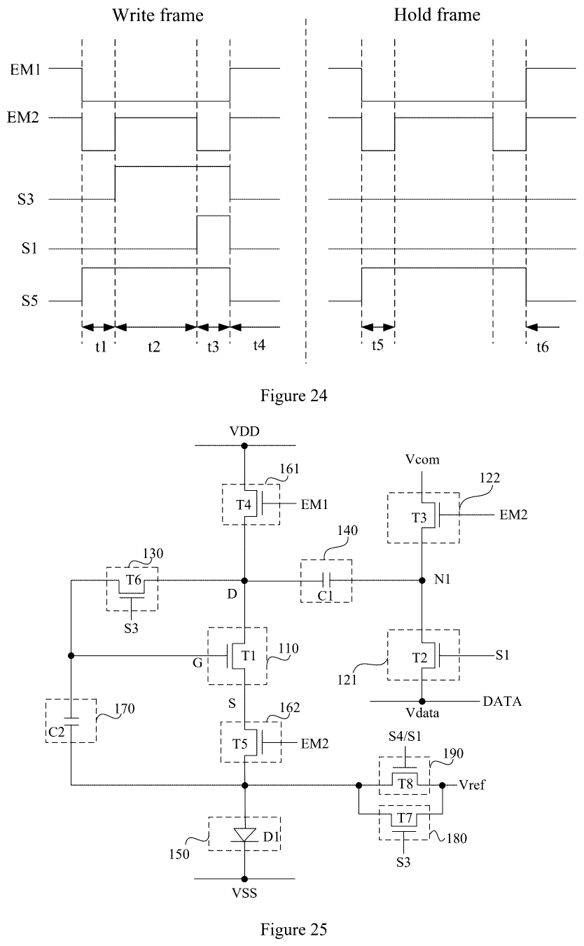

FIG. 23 is a schematic diagram of a structure of another pixel circuit according to an embodiment of the present application. With reference to FIG. 23, on the basis of the above-described embodiments, the control terminal of the second initialization module 180 is connected to a fifth scan line, that is, the gate of the seventh transistor T7 is connected to the fifth scan line, to be connected to a fifth scan signal transmitted by the fifth scan line. The fifth scan signal S5 is different from the third scan signal S3. FIG. 24 is a schematic diagram of driving timing of another pixel circuit according to an embodiment of the present application, applicable to the pixel circuit shown in FIG. 23. With reference to FIG. 23 and FIG. 24, an operating process of the pixel circuit includes the following:

In the write frame, in the initialization phase t1, the first scan signal S1 is at an off level, such as a low level. The third scan signal S3 is at an off level, such as a low level. The fifth scan signal S5 is at an on level, such as a high level. The first light-emission control signal EM1 is at an off level, such as a low level. The second light-emission control signal EM2 is at an off level, such as a low level. Therefore, the seventh transistor T7 is turned on. The initialization voltage Vref is transmitted through the seventh transistor T7 to the first electrode of the light-emitting diode D1, to initialize the first electrode of the light-emitting diode D1.

In the compensation phase t2, the first scan signal S1 is at an off level, such as a low level. The third scan signal S3 is at an on level, such as a high level. The fifth scan signal S5 is at an on level, such as a high level. The first light-emission control signal EM1 is at an off level, such as a low level. The second light-emission control signal EM2 is at an on level, such as a high level. Therefore, the third transistor T3, the fifth transistor T5, the sixth transistor T6, and the seventh transistor T7 are turned on. For the compensation phase t2, refer to the related descriptions of the operating process of the pixel circuit shown in FIG. 19, and details are not described herein again.

In the data writing phase t3, the first scan signal S1 is at an on level, such as a high level. The third scan signal S3 is at an on level, such as a high level. The fifth scan signal S5 is at an on level, such as a high level. The first light-emission control signal EM1 is at an off level, such as a low level. The second light-emission control signal EM2 is at an off level, such as a low level. Therefore, the second transistor T2, the sixth transistor T6, and the seventh transistor T7 are turned on. The first electrode of the light-emitting diode D1 is initialized by the seventh transistor T7 while the data voltage Vdata is written into the gate of the first transistor T1.

In the light-emission phase t4, the first scan signal S1 is at an off level, such as a low level. The third scan signal S3 is at an off level, such as a low level. The fifth scan signal S5 is at an off level, such as a low level. The first light-emission control signal EM1 is at an on level, such as a high level. The second light-emission control signal EM2 is at an on level, such as a high level. The first transistor T1 generates a drive current I based on the voltages of the gate of the first transistor and the point D, to drive the light-emitting diode D1 to emit light. In addition, the third transistor T3 transmits the fixed voltage Vcom to the first terminal of the first capacitor C1, to initialize the first capacitor C1.

In an initialization phase t5 in the hold frame, the first scan signal S1 is at an off level, such as a low level. The third scan signal S3 is at an off level, such as a low level. The fifth scan signal S5 is at an on level, such as a high level. The first light-emission control signal EM1 is at an off level, such as a low level. The second light-emission control signal EM2 is at an off level, such as a low level. Therefore, the seventh transistor T7 is turned on. The initialization voltage Vref is transmitted through the seventh transistor T7 to the first electrode of the light-emitting diode D1, to initialize the first electrode of the light-emitting diode D1.

The operating process of a light-emission phase t6 in the hold frame is the same as that in the light-emission phase t4 in the write frame.

In this embodiment, high frequency resetting can be performed on the first electrode of the light-emitting diode D1 in the hold frame, thereby mitigating a case that the light-emission phase is prone to flicker.

FIG. 25 is a schematic diagram of a structure of another pixel circuit according to an embodiment of the present application. With reference to FIG. 25, when the control terminal of the compensation module 130 and the control terminal of the second initialization module 180 are connected to a same scan line, in one embodiment, the pixel circuit further includes a third initialization module 190, a control terminal of the third initialization module 190 is connected to a fourth scan line, a first terminal of the third initialization module 190 is connected to an initialization signal line, a second terminal of the third initialization module 190 is connected to the first terminal of the light-emitting module 150, and the third initialization module 190 is configured to transmit the initialization voltage Vref to the first terminal of the light-emitting module 150 in a write frame within a display period and transmit the initialization voltage Vref to the first terminal of the light-emitting module 150 in a hold frame within the same display period.

The third initialization module 190 includes an eighth transistor T8, a gate of the eighth transistor T8 is connected to the fourth scan line, a first electrode of the eighth transistor T8 is connected to the initialization signal line, and a second electrode of the eighth transistor T8 is connected to the first terminal of the light-emitting module 150.

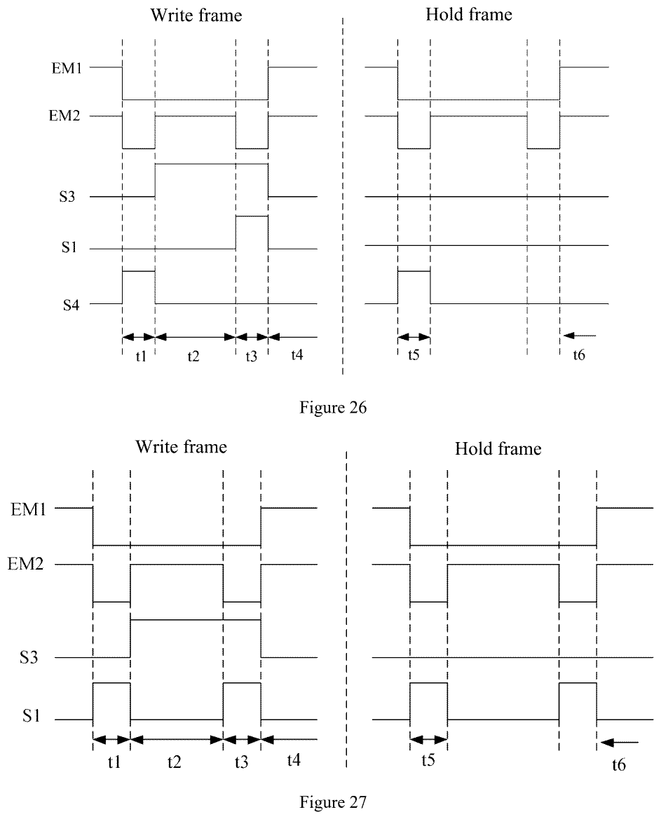

FIG. 26 is a schematic diagram of driving timing of another pixel circuit according to an embodiment of the present application, applicable to the pixel circuit shown in FIG. 25. With reference to FIG. 25 and FIG. 26, a write frame includes an initialization phase t1, a compensation phase t2, a data writing phase t3, and a light-emission phase t4, and a hold frame includes an initialization phase t5 and a light-emission phase t6.

In the write frame, in the initialization phase t1, the first scan signal S1 is at an off level, such as a low level. The third scan signal S3 is at an off level, such as a low level. A fourth scan signal S4 is at an on level, such as a high level. The first light-emission control signal EM1 is at an off level, such as a low level. The second light-emission control signal EM2 is at an off level, such as a low level. Therefore, the eighth transistor T8 is turned on. The initialization voltage Vref is transmitted through the eighth transistor T8 to the first electrode of the light-emitting diode D1, to initialize the first electrode of the light-emitting diode D1.

In the compensation phase t2, the first scan signal S1 is at an off level, such as a low level. The third scan signal S3 is at an on level, such as a high level. The fourth scan signal S4 is at an off level, such as a low level. The first light-emission control signal EM1 is at an off level, such as a low level. The second light-emission control signal EM2 is at an on level, such as a high level. Therefore, the third transistor T3, the fifth transistor T5, the sixth transistor T6, and the seventh transistor T7 are turned on.

In the data writing phase t3, the first scan signal S1 is at an on level, such as a high level. The third scan signal S3 is at an on level, such as a high level. The fourth scan signal S4 is at an off level, such as a low level. The first light-emission control signal EM1 is at an off level, such as a low level. The second light-emission control signal EM2 is at an off level, such as a low level. Therefore, the second transistor T2, the sixth transistor T6, and the seventh transistor T7 are turned on.

For the compensation phase t2 and the data writing phase t3, refer to the related descriptions of the operating process of the pixel circuit shown in FIG. 19, and details are not described herein again.

In the light-emission phase t4, the first scan signal S1 is at an off level, such as a low level. The third scan signal S3 is at an off level, such as a low level. The fourth scan signal S4 is at an off level, such as a low level. The first light-emission control signal EM1 is at an on level, such as a high level. The second light-emission control signal EM2 is at an on level, such as a high level. Therefore, the third transistor T3, the fourth transistor T4, and the fifth transistor T5 are turned on. The first supply voltage VDD is transmitted to the point D through the fourth transistor T4, and the first transistor T1 generates a drive current I based on the voltages of the gate of the first transistor and the point D, to drive the light-emitting diode D1 to emit light. In addition, the third transistor T3 transmits the fixed voltage Vcom to the first terminal of the first capacitor C1, to initialize the first capacitor C1.

In an initialization phase t5 in the hold frame, the first scan signal S1 is at an off level, such as a low level. The third scan signal S3 is at an off level, such as a low level. A fourth scan signal S4 is at an on level, such as a high level. The first light-emission control signal EM1 is at an off level, such as a low level. The second light-emission control signal EM2 is at an off level, such as a low level. Therefore, the eighth transistor T8 is turned on. The initialization voltage Vref is transmitted through the eighth transistor T8 to the first electrode of the light-emitting diode D1, to initialize the first electrode of the light-emitting diode D1.

In the light-emission phase t6 in the hold frame, the first scan signal S1 is at an off level, such as a low level. The third scan signal S3 is at an off level, such as a low level. The fourth scan signal S4 is at an off level, such as a low level. The first light-emission control signal EM1 is at an on level, such as a high level. The second light-emission control signal EM2 is at an on level, such as a high level. Therefore, the third transistor T3, the fourth transistor T4, and the fifth transistor T5 are turned on. The first supply voltage VDD is transmitted to the point D through the fourth transistor T4, and the first transistor T1 drives the light-emitting diode D1 to emit light again. In addition, the third transistor T3 transmits the fixed voltage Vcom to the first terminal of the first capacitor C1, to initialize the first capacitor C1.

In one embodiment, with continued reference to FIG. 25, the gate of the eighth transistor T8 may also be connected to the first scan signal S1, and the gate of the eighth transistor shares the same first scan line with the gate of the second transistor T2. FIG. 27 is a schematic diagram of driving timing of another pixel circuit according to an embodiment of the present application, applicable to the pixel circuit shown in FIG. 25. The first scan line is reused as the fourth scan line.

In the write frame, in the initialization phase t1, the first scan signal S1 is at an on level, such as a high level. The third scan signal S3 is at an off level, such as a low level. The first light-emission control signal EM1 is at an off level, such as a low level. The second light-emission control signal EM2 is at an off level, such as a low level. Therefore, the second transistor T2 and the eighth transistor T8 are turned on. The initialization voltage Vref is transmitted through the eighth transistor T8 to the first electrode of the light-emitting diode D1, to initialize the first electrode of the light-emitting diode D1. Because the sixth transistor T6 is turned off, even if the second transistor T2 is turned on, a potential of the gate of the first transistor T1 is not affected.

In the data writing phase t3, the first scan signal S1 is at an on level, such as a high level. The third scan signal S3 is at an on level, such as a high level. The first light-emission control signal EM1 is at an off level, such as a low level. The second light-emission control signal EM2 is at an off level, such as a low level. Therefore, the second transistor T2, the sixth transistor T6, the seventh transistor T7, and the eighth transistor T8 are turned on. The first electrode of the light-emitting diode D1 is initialized by the eighth transistor T8 while the data voltage Vdata is written into the gate of the first transistor T1.

For operating processes in other phases, refer to the related descriptions of the driving timing shown in FIG. 26, and details are not described again. The pixel circuit provided in this embodiment also has the beneficial effects described in any of the above embodiments.

The inventors verified through experiment that when the data voltage Vdata is within a range of 1 V to 7 V, the pixel circuit provided in any of the above embodiments can cover a drive current corresponding to gray levels of 0 to 255, facilitating grayscale expansion.

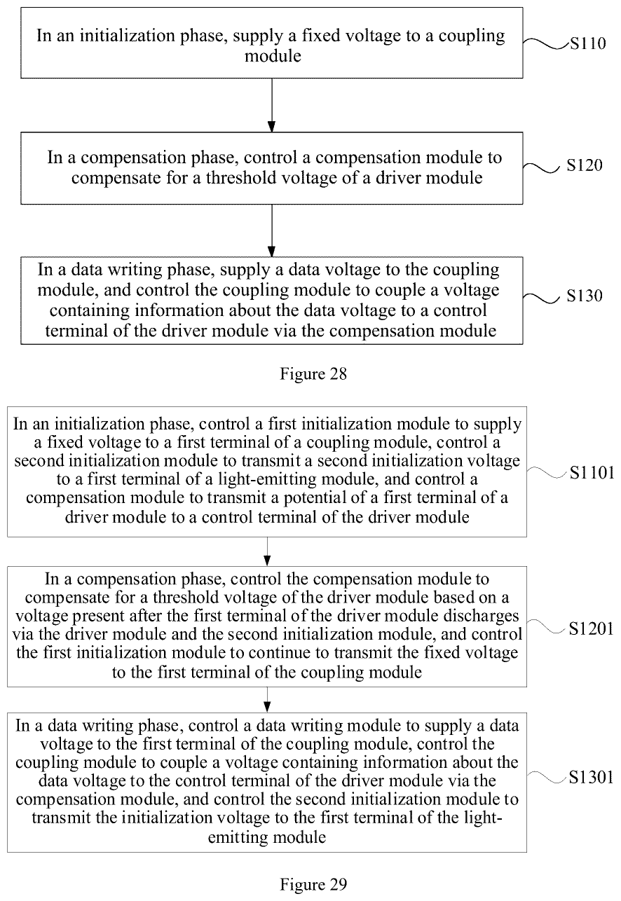

An embodiment of the present application further provides a driving method for a pixel circuit, which can be used to drive the pixel circuit according to any of the embodiments of the present application. FIG. 28 is a flowchart of a driving method for a pixel circuit according to an embodiment of the present application. With reference to FIG. 28, the driving method for a pixel circuit includes the following steps:

S110: In an initialization phase, supply a fixed voltage to a coupling module.

S120: In a compensation phase, control a compensation module to compensate for a threshold voltage of a driver module.

S130: In a data writing phase, supply a data voltage to the coupling module, and control the coupling module to couple a voltage containing information about the data voltage to a control terminal of the driver module via the compensation module.

In the driving method for a pixel circuit provided in this embodiment of the present application, the compensation module is controlled to compensate for the threshold voltage of the driver module in the compensation phase based on a voltage present after a first terminal of the driver module discharges via the driver module. In the data writing phase, a voltage transmitted from a signal supply terminal to a first terminal of the coupling module is controlled to jump from the fixed voltage to the data voltage, and the coupling module couples the data voltage to the control terminal of the driver module via the compensation module, to write the data voltage. In this embodiment, threshold compensation and data writing for the driver module are performed at different times, and the threshold compensation is performed before the data voltage is written into the control terminal of the driver module, and the threshold compensation phase and the data writing phase do not affect each other. In this way, the time of the threshold compensation is not affected by the data writing phase. Even at a high refresh rate, the threshold voltage of the driver module can be fully compensated, and variations in driver module characteristics corresponding to different pixels can be reduced, thereby facilitating the mitigation of variations in display brightness and the enhancement of uniformity of display quality.

In one embodiment, with reference to FIG. 19, the pixel circuit further includes a second initialization module 180 and a light-emitting module 150, and the driving method further includes: at least in the compensation phase, controlling the second initialization module 180 to transmit an initialization voltage Vref to a first terminal of the light-emitting module 150.

In one embodiment, the pixel circuit further includes a data writing module 121 and a first initialization module 122. FIG. 29 is a flowchart of another driving method for a pixel circuit according to an embodiment of the present application. With reference to FIG. 28 and FIG. 29, step S110 specifically includes:

S1101: In the initialization phase, control the first initialization module to supply the fixed voltage to the first terminal of the coupling module, control the second initialization module to transmit a second initialization voltage to the first terminal of the light-emitting module, and control the compensation module to transmit a potential of the first terminal of the driver module to the control terminal of the driver module.

Step S120 specifically includes:

S1201: In the compensation phase, control the compensation module to compensate for the threshold voltage of the driver module based on a voltage present after the first terminal of the driver module discharges via the driver module and the second initialization module, and control the first initialization module to continue to transmit the fixed voltage to the first terminal of the coupling module.

Specifically, the first terminal of the driver module is controlled to discharge via the driver module, a second light-emission control module, and the second initialization module until the driver module is turned off, and the compensation module transmits the voltage present after the first terminal of the driver module discharges to the control terminal of the driver module, to compensate for the threshold voltage of the driver module.

Step S130 specifically includes:

S1301: In the data writing phase, control the data writing module to supply the data voltage to the first terminal of the coupling module, control the coupling module to couple the voltage containing the information about the data voltage to the control terminal of the driver module via the compensation module, and control the second initialization module to transmit the initialization voltage to the first terminal of the light-emitting module.

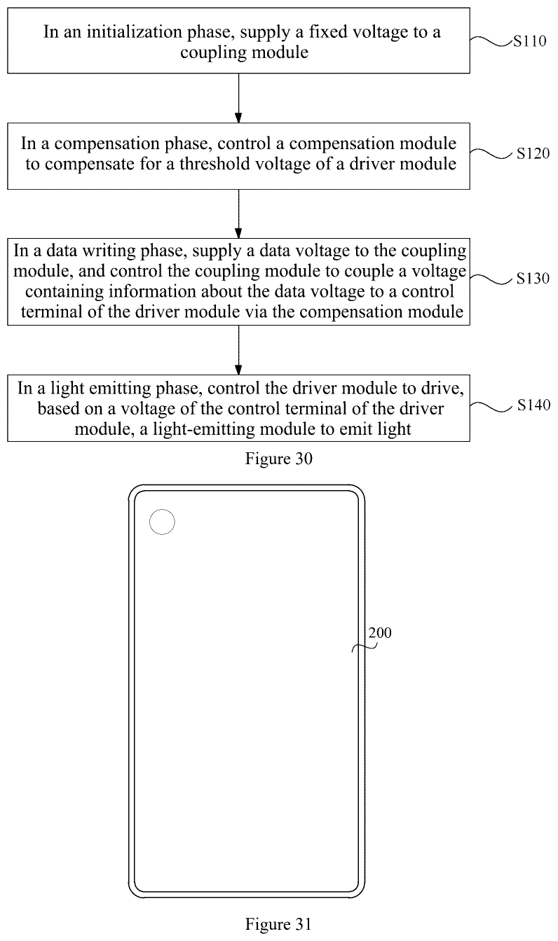

FIG. 30 is a flowchart of another driving method for a pixel circuit according to an embodiment of the present application. With reference to FIG. 30, after step S130, the driving method further includes:

S140: In a light-emission phase, control the driver module to drive, based on a voltage of the control terminal of the driver module, the light-emitting module to emit light.

Since the driving method for a pixel circuit provided in this embodiment can be used to drive the pixel circuit according to any of the above embodiments, the driving method for a pixel circuit also possesses the beneficial effects described in any of the above embodiments.

An embodiment of the present application further provides a display panel, including the pixel circuit provided in the above embodiments. Therefore, the display panel also possesses the beneficial effects described in any of the above embodiments. FIG. 31 is a schematic diagram of a structure of a display panel according to an embodiment of the present application. In this embodiment, the display panel 200 may be used in a mobile phone, or may be used in any electronic product with a display function, including but not limited to the following categories: a TV set, a notebook computer, a desktop monitor, a tablet computer, a digital camera, a smart bracelet, smart glasses, a vehicle-mounted display, a medical apparatus, an industrial control apparatus, a touch interaction terminal, etc., which is not specifically limited in the embodiments of the present application.

It should be understood that the steps may be reordered, added, or deleted using the various forms of processes illustrated above. For example, the steps recorded in the present application may be performed in parallel, sequentially, or in a different order, provided that desired results of the embodiments of the present application can be achieved, which are not limited here.

The above detailed description does not constitute a limitation on the scope of protection of the present application. Various modifications, combinations, sub-combinations, and replacements can be made depending on design requirements and other factors. Any modifications, equivalent substitutions, or improvements made within the spirit and principle of the present application should be included within the scope of protection of the present application.

1. A pixel circuit, comprising: a driver module, a signal supply terminal, a compensation module, and a coupling module, wherein
the compensation module is configured to compensate for a threshold voltage of the driver module in a compensation phase; and
the signal supply terminal supplies a fixed voltage to the coupling module in an initialization phase and supplies a data voltage to the coupling module in a data writing phase, and the coupling module is configured to couple a voltage containing information about the data voltage to a control terminal of the driver module via the compensation module in the data writing phase, wherein the data writing phase is later than the compensation phase.

2. The pixel circuit according to claim 1, wherein a start time of the data writing phase is later than an end time of the compensation phase.

3. The pixel circuit according to claim 1, further comprising a second initialization module, wherein the second initialization module is configured to control, in the compensation phase, a first terminal of the driver module to discharge via the driver module and the second initialization module, and the compensation module is configured to compensate for the threshold voltage of the driver module in the compensation phase based on a voltage present after the first terminal of the driver module discharges.

4. The pixel circuit according to claim 3, further comprising a first light-emission control module and a second light-emission control module, wherein the first light-emission control module is configured to transmit a first supply voltage to the first terminal of the driver module in the initialization phase and a light-emission phase; and
the second light-emission control module is configured to transmit a voltage of the first terminal of the driver module to the second initialization module in the compensation phase for discharging; and the second light-emission control module is further configured to transmit a drive current generated by the driver module to a light-emitting module in the light-emission phase.

5. The pixel circuit according to claim 3, further comprising a light-emitting module, wherein
the second initialization module is further configured to transmit an initialization voltage to the light-emitting module at least in the initialization phase;
the pixel circuit further comprises a storage module configured to store a voltage difference between the control terminal of the driver module and a first terminal of the light-emitting module.

6. The pixel circuit according to claim 1, wherein
the compensation module is connected between a control terminal and a first terminal of the driver module; and
the coupling module is connected between the first terminal of the driver module and the signal supply terminal.

7. The pixel circuit according to claim 4, further comprising a light-emitting module, wherein
the first light-emission control module is connected between a first supply voltage terminal and the first terminal of the driver module, the second light-emission control module is connected between a second terminal of the driver module and a first terminal of the light-emitting module, and a second terminal of the light-emitting module is connected to a second supply voltage terminal; and a control terminal of the first light-emission control module is connected to a first light-emission control signal line, and a control terminal of the second light-emission control module is connected to a second light-emission control signal line.

8. The pixel circuit according to claim 3, further comprising a second initialization module connected between an initialization signal line and the first terminal of the light-emitting module, with a control terminal of the second initialization module connected to a third scan line, wherein
a control terminal of the compensation module is connected to a first scan line;
a control terminal of the compensation module is connected to the third scan line; the pixel circuit further comprises a storage module connected between the control terminal of the driver module and the first terminal of the light-emitting module.

9. The pixel circuit according to claim 8, wherein the driver module comprises a first transistor, the first light-emission control module comprises a fourth transistor, the second light-emission control module comprises a fifth transistor, and the light-emitting module comprises a light-emitting diode, wherein
a gate of the fourth transistor is connected to the first light-emission control signal line, a first electrode of the fourth transistor is connected to the first supply voltage terminal, a second electrode of the fourth transistor is connected to a first electrode of the first transistor, a second electrode of the first transistor is connected to a first electrode of the fifth transistor, a second electrode of the fifth transistor is connected to a first electrode of the light-emitting diode, a second electrode of the light-emitting diode is connected to the second supply voltage terminal, and a gate of the fifth transistor is connected to the second light-emission control signal line; and
the coupling module comprises a first capacitor, the compensation module comprises a sixth transistor, and the second initialization module comprises a seventh transistor; and a first electrode of the first capacitor is connected to the signal supply terminal, a second electrode of the first capacitor is connected to a first electrode of the first transistor, a first electrode of the sixth transistor is connected to the first electrode of the first transistor, a second electrode of the sixth transistor is connected to a gate of the first transistor, a gate of the sixth transistor is connected to the first scan line, a first electrode of the seventh transistor is connected to the initialization signal line, a second electrode of the seventh transistor is connected to a first electrode of the light-emitting diode, and a gate of the seventh transistor is connected to the third scan line; and the storage module comprises a second capacitor, a first electrode of the second capacitor is connected to the control terminal of the driver module, and a second electrode of the second capacitor is connected to the first terminal of the light-emitting module.

10. A pixel circuit, comprising: a driver module, a data writing module, a first initialization module, a compensation module, and a coupling module, wherein
the compensation module is connected between a control terminal and a first terminal of the driver module, and the compensation module is configured to compensate for a threshold voltage of the driver module;
the data writing module and the first initialization module are connected at a first node; and
the coupling module is connected between the first terminal of the driver module and the first node, the first initialization module is configured to transmit a fixed voltage to the coupling module, and the coupling module is configured to couple, to the control terminal of the driver module via the compensation module, a voltage transmitted by the data writing module and containing information about a data voltage.

11. The pixel circuit according to claim 10, wherein the data writing module comprises a second transistor, a gate of the second transistor is connected to a first scan line, a first electrode of the second transistor is connected to a data line, and a second electrode of the second transistor is connected to the first node; and
the first initialization module comprises a third transistor, a gate of the third transistor is connected to a second scan line, a first electrode of the third transistor is connected to the fixed voltage, and a second electrode of the third transistor is connected to the first node.

12. The pixel circuit according to claim 11, further comprising a first light-emission control module and a second light-emission control module, wherein
the first light-emission control module is connected between a first supply voltage terminal and the first terminal of the driver module, the second light-emission control module is connected between a second terminal of the driver module and a first terminal of a light-emitting module, and a second terminal of the light-emitting module is connected to a second supply voltage terminal; and a control terminal of the first light-emission control module is connected to a first light-emission control signal line, and a control terminal of the second light-emission control module is connected to a second light-emission control signal line.

13. The pixel circuit according to claim 11, wherein a control terminal of the compensation module is connected to a third scan line, wherein
the pixel circuit further comprises a second initialization module, a control terminal of the second initialization module is connected to the third scan line, a first terminal of the second initialization module is connected to an initialization signal line, a second terminal of the second initialization module is connected to a first terminal of a light-emitting module, and the second initialization module is configured to transmit an initialization voltage on the initialization signal line to the first terminal of the light-emitting module; or
the pixel circuit further comprises a second initialization module, a control terminal of the second initialization module is connected to a fifth scan line, a first terminal of the second initialization module is connected to an initialization signal line, a second terminal of the second initialization module is connected to a first terminal of a light-emitting module, and the second initialization module is configured to transmit an initialization voltage on the initialization signal line to the first terminal of the light-emitting module.

14. The pixel circuit according to claim 11, wherein
the pixel circuit further comprises a light-emitting module, and the driver module and the light-emitting module are connected between a first supply voltage terminal and a second supply voltage terminal, wherein the driver module is configured to drive the light-emitting module to emit light; and/or
the pixel circuit further comprises a light-emitting module, and the driver module and the light-emitting module are connected between a first supply voltage terminal and a second supply voltage terminal, wherein a first supply voltage to which the first supply voltage terminal is connected is the same as the fixed voltage; and
the pixel circuit further comprises a first light-emission control module and a second light-emission control module, a control terminal of the first light-emission control module is connected to a first light-emission control signal line, and a control terminal of the second light-emission control module is connected to a second light-emission control signal line, wherein the second light-emission control signal line is reused as the second scan line; and
the pixel circuit further comprises a light-emitting module, the driver module and the light-emitting module are connected between a first supply voltage terminal and a second supply voltage terminal, the pixel circuit further comprises a first light-emission control module and a second light-emission control module, a control terminal of the first light-emission control module is connected to a first light-emission control signal line, and a control terminal of the second light-emission control module is connected to a second light-emission control signal line, wherein the driver module comprises a first transistor, the first light-emission control module comprises a fourth transistor, the second light-emission control module comprises a fifth transistor, and the light-emitting module comprises a light-emitting diode; and a gate of the fourth transistor is connected to the first light-emission control signal line, a first electrode of the fourth transistor is connected to the first supply voltage terminal, a second electrode of the fourth transistor is connected to a first electrode of the first transistor, a second electrode of the first transistor is connected to a first electrode of the fifth transistor, a second electrode of the fifth transistor is connected to a first electrode of the light-emitting diode, a second electrode of the light-emitting diode is connected to the second supply voltage terminal, and a gate of the fifth transistor is connected to the second light-emission control signal line; and
the pixel circuit further comprises a light-emitting module, a second initialization module, and a third initialization module, a first terminal of the second initialization module is connected to an initialization signal line, a control terminal of the third initialization module is connected to a fourth scan line, a first terminal of the third initialization module is connected to the initialization signal line, a second terminal of the third initialization module is connected to a first terminal of the light-emitting module, and the third initialization module is configured to transmit an initialization voltage on the initialization signal line to the first terminal of the light-emitting module in a write frame within a display period and transmit the initialization voltage to the first terminal of the light-emitting module in a hold frame within the same display period; and
the pixel circuit further comprises a second initialization module, a control terminal of the compensation module is connected to a third scan line, a control terminal of the second initialization module is connected to the third scan line, and a first terminal of the second initialization module is connected to an initialization signal line, wherein the compensation module comprises a sixth transistor, the second initialization module comprises a seventh transistor, a gate of the sixth transistor and a gate of the seventh transistor are separately connected to the third scan line, a first electrode of the sixth transistor is connected to the first terminal of the driver module, a second electrode of the sixth transistor is connected to the control terminal of the driver module, a first electrode of the seventh transistor is connected to the initialization signal line, and a second electrode of the seventh transistor is connected to a first terminal of a light-emitting module; and
the pixel circuit further comprises a second initialization module and a third initialization module, a first terminal of the second initialization module is connected to an initialization signal line, and a control terminal of the third initialization module is connected to a fourth scan line, wherein the third initialization module comprises an eighth transistor, a gate of the eighth transistor is connected to the fourth scan line, a first electrode of the eighth transistor is connected to the initialization signal line, and a second electrode of the eighth transistor is connected to a first terminal of a light-emitting module; and
the pixel circuit further comprises a third initialization module, a control terminal of the third initialization module is connected to a fourth scan line, and the first scan line is reused as the fourth scan line; and
the pixel circuit further comprises a storage module connected between the control terminal of the driver module and a first terminal of a light-emitting module, the storage module comprises a second capacitor, a first electrode of the second capacitor is connected to the control terminal of the driver module, and a second electrode of the second capacitor is connected to the first terminal of the light-emitting module.

15. A driving method for a pixel circuit, comprising:
in an initialization phase, supplying a fixed voltage to a coupling module;
in a compensation phase, controlling a compensation module to compensate for a threshold voltage of a driver module; and
in a data writing phase, supplying a data voltage to the coupling module, and controlling the coupling module to couple a voltage containing information about the data voltage to a control terminal of the driver module via the compensation module.

16. The driving method for a pixel circuit according to claim 15, wherein the pixel circuit further comprises a second initialization module and a light-emitting module, and at least in the compensation phase, the second initialization module is controlled to transmit an initialization voltage to a first terminal of the light-emitting module.

17. The driving method for a pixel circuit according to claim 16, wherein
the controlling a compensation module to compensate for a threshold voltage of a driver module comprises: controlling the compensation module to compensate for the threshold voltage of the driver module based on a voltage present after a first terminal of the driver module discharges via the driver module and the second initialization module; or
in the data writing phase, the driving method for a pixel circuit further comprises: controlling the second initialization module to transmit the initialization voltage to the first terminal of the light-emitting module; or
the driving method further comprises: in a light-emission phase, controlling the driver module to drive, based on a voltage of the control terminal of the driver module, the light-emitting module to emit light.

18. The driving method for a pixel circuit according to claim 17, the pixel circuit further comprising a data writing module and a first initialization module, wherein the supplying a fixed voltage to a coupling module comprises: controlling the first initialization module to supply the fixed voltage to a first terminal of the coupling module; and the supplying a data voltage to the coupling module comprises:
controlling the data writing module to supply the data voltage to the first terminal of the coupling module; or
in the initialization phase, the driving method for a pixel circuit further comprises: controlling the second initialization module to transmit the initialization voltage to the first terminal of the light-emitting module, and controlling the compensation module to transmit a potential of the first terminal of the driver module to the control terminal of the driver module; or
in the compensation phase, the driving method for a pixel circuit further comprises: controlling the first initialization module to continue to transmit the fixed voltage to a first terminal of the coupling module.
